(19) United States
(12) Patent Application Publication
(10) Pub. No.: US 2023/0169672 A1
(43) Pub. Date: Jun. 1, 2023

(54) ELEVATOR 3D DATA PROCESSING DEVICE

(71) Applicant: Mitsubishi Electric Corporation, Tokyo (JP)

(72) Inventor: Haruyuki IWAMA, Tokyo (JP)

(73) Assignee: Mitsubishi Electric Corporation, Tokyo (JP)

(21) Appl. No.: 17/919,539

(22) PCT Filed: Apr. 27, 2020
(86) PCT No.: PCT/JP2020/017983

§ 371 Date: Oct. 18, 2022

(51) Int. Cl. G06T 7/60; G06T 7/73; G06T 7/33; G06T 11/00

(52) U.S. Cl. CPC G06T 7/60; G06T 7/73; G06T 7/33; G06T 11/00; G06T 2207/20068; G06T 2207/20021

(57) ABSTRACT

To provide an elevator 3D data processing device that can reduce a load of calculation. The elevator 3D data processing device includes a projection image generating unit that, when 3D data of a shaft of an elevator is aligned with a preset coordinate system, generates a 2D projection image from the 3D data, a projection image feature extracting unit that extracts a feature of the projection image generated by the projection image generating unit, and a reference position specifying unit that specifies a reference position for processing of the 3D data from the feature extracted by the projection image feature extracting unit.

### FIELD

The present disclosure relates to an elevator 3D data processing device.

### BACKGROUND

PTL 1 discloses an elevator data processing device. With the processing device, it is possible to calculate dimensions of structures in data of a shaft.

### Citation List

### Patent Literature

[PTL 1] Japanese Patent No. 6322544

### SUMMARY

### Technical Problem

However, the processing device described in PTL 1 needs to perform 3D model generation. Therefore, a heavy load is placed on the processing device.

The present disclosure has been made to solve the problem described above. An object of the present disclosure is to provide an elevator 3D data processing device that can reduce a load of calculation.

### Solution to Problem

An elevator 3D data processing device according to the present disclosure includes: a projection image generating unit that, when 3D data of a shaft of an elevator is aligned with a preset coordinate system, generates a 2D projection image from the 3D data; a projection image feature extracting unit that extracts a feature of the projection image generated by the projection image generating unit; and a reference position specifying unit that specifies a reference position for processing of the 3D data from the feature extracted by the projection image feature extracting unit.

### Advantageous Effects

According to the present disclosure, the processing device generates the 2D projection image from the 3D data of the shaft. The processing device extracts the feature from the 2D projection image. The processing device specifies the reference position for the processing of the 3D data of the shaft from the feature of the 2D projection image. Therefore, it is possible to reduce the load of calculation.

### BRIEF DESCRIPTION OF DRAWINGS

FIG. 1 is a block diagram of a processing system to which an elevator 3D data processing device in a first embodiment is applied;

FIG. 2 is a diagram for explaining a 3D data input unit A of the processing system to which the elevator 3D data processing device in the first embodiment is applied;

FIG. 3 is a diagram for explaining a reference straight line extracting unit and a first aligning unit of the elevator 3D data processing device in the first embodiment;

FIG. 4 is a diagram for explaining the reference straight line extracting unit of the elevator 3D data processing device in the first embodiment;

FIG. 5 is a diagram for explaining the reference straight line extracting unit of the elevator 3D data processing device in the first embodiment;

FIG. 6 is a diagram for explaining the reference straight line extracting unit of the elevator 3D data processing device in the first embodiment;

FIG. 7 is a diagram for explaining the reference straight line extracting unit of the elevator 3D data processing device in the first embodiment;

FIG. 8 is a diagram for explaining a reference plane extracting unit of the elevator 3D data processing device in the first embodiment;

FIG. 9 is a diagram for explaining the reference plane extracting unit of the elevator 3D data processing device in the first embodiment;

FIG. 10 is a diagram for explaining the reference plane extracting unit of the elevator 3D data processing device in the first embodiment;

FIG. 11 is a diagram for explaining the reference plane extracting unit of the elevator 3D data processing device in the first embodiment;

FIG. 12 is a diagram for explaining a second aligning unit of the elevator 3D data processing device in the first embodiment;

FIG. 13 is a diagram for explaining a projection image generating unit of the elevator 3D data processing device in the first embodiment;

FIG. 14 is a diagram for explaining the projection image generating unit of the elevator 3D data processing device in the first embodiment;

FIG. 15 is a diagram for explaining the projection image generating unit of the elevator 3D data processing device in the first embodiment;

FIG. 16 is a diagram for explaining a projection image feature extracting unit of the elevator 3D data processing device in the first embodiment;

FIG. 17 is a diagram for explaining the projection image feature extracting unit of the elevator 3D data processing device in the first embodiment;

FIG. 18 is a diagram for explaining the projection image feature extracting unit of the elevator 3D data processing device in the first embodiment;

FIG. 19 is a diagram for explaining the projection image feature extracting unit of the elevator 3D data processing device in the first embodiment;

FIG. 20 is a diagram for explaining the projection image feature extracting unit of the elevator 3D data processing device in the first embodiment;

FIG. 21 is a diagram for explaining the projection image feature extracting unit of the elevator 3D data processing device in the first embodiment;

FIG. 22 is a diagram for explaining the projection image feature extracting unit of the elevator 3D data processing device in the first embodiment;

FIG. 23 is a diagram for explaining the projection image feature extracting unit of the elevator 3D data processing device in the first embodiment;

FIG. 24 is a diagram for explaining the projection image feature extracting unit of the elevator 3D data processing device in the first embodiment;

FIG. 25 is a diagram for explaining the projection image feature extracting unit of the elevator 3D data processing device in the first embodiment;

FIG. 26 is a diagram for explaining a dimension calculating unit of the elevator 3D data processing device in the first embodiment;

FIG. 27 is a diagram for explaining the dimension calculating unit of the elevator 3D data processing device in the first embodiment;

FIG. 28 is a diagram for explaining the dimension calculating unit of the elevator 3D data processing device in the first embodiment;

FIG. 29 is a hardware block diagram of the elevator 3D data processing device in the first embodiment;

FIG. 30 is a diagram for explaining an elevator 3D data processing device in a second embodiment;

FIG. 31 is a diagram for explaining the elevator 3D data processing device in the second embodiment;

FIG. 32 is a diagram for explaining the elevator 3D data processing device in the second embodiment;

FIG. 33 is a diagram for explaining the elevator 3D data processing device in the second embodiment;

FIG. 34 is a diagram for explaining the elevator 3D data processing device in the second embodiment;

FIG. 35 is a block diagram of a processing system to which an elevator 3D data processing device in a third embodiment is applied;

FIG. 36 is a diagram for explaining a plane extracting unit of the elevator 3D data processing device in the third embodiment;

FIG. 37 is a diagram for explaining an initial aligning unit of the elevator 3D data processing device in the third embodiment;

FIG. 38 is a diagram for explaining the initial aligning unit of the elevator 3D data processing device in the third embodiment;

FIG. 39 is a diagram for explaining the initial aligning unit of the elevator 3D data processing device in the third embodiment;

FIG. 40 is a diagram for explaining the initial aligning unit of the elevator 3D data processing device in the third embodiment;

FIG. 41 is a diagram for explaining the initial aligning unit of the elevator 3D data processing device in the third embodiment;

FIG. 42 is a diagram for explaining the initial aligning unit of the elevator 3D data processing device in the third embodiment;

FIG. 43 is a diagram for explaining the initial aligning unit of the elevator 3D data processing device in the third embodiment;

FIG. 44 is a diagram for explaining the initial aligning unit of the elevator 3D data processing device in the third embodiment;

FIG. 45 is a diagram for explaining the initial aligning unit of the elevator 3D data processing device in the third embodiment;

FIG. 46 is a diagram for explaining the initial aligning unit of the elevator 3D data processing device in the third embodiment;

FIG. 47 is a diagram for explaining the initial aligning unit 11 of the elevator 3D data processing device in the third embodiment; and

FIG. 48 is a diagram for explaining the initial aligning unit of the elevator 3D data processing device in the third embodiment.

### DESCRIPTION OF EMBODIMENTS

Embodiments are explained with reference to the accompanying drawings. Note that, in the figures, the same or equivalent portions are denoted by the same reference numerals and signs. Redundant explanation of the portions is simplified or omitted as appropriate.

### First Embodiment

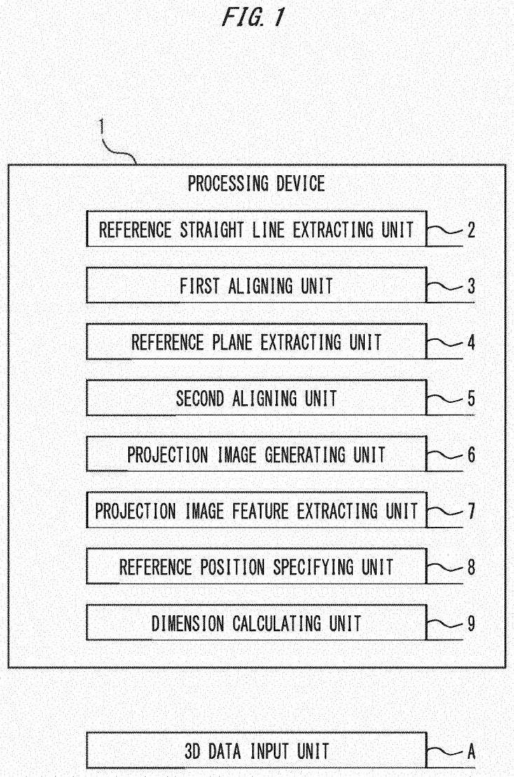

FIG. 1 is a block diagram of a processing system to which an elevator 3D data processing device in a first embodiment is applied.

As shown in FIG. 1, the processing system includes a 3D data input unit A and a processing device 1.

The processing device 1 includes a reference straight line extracting unit 2, a first aligning unit 3, a reference plane extracting unit 4, a second aligning unit 5, a projection image generating unit 6, a projection image feature extracting unit 7, a reference position specifying unit 8, and a dimension calculating unit 9.

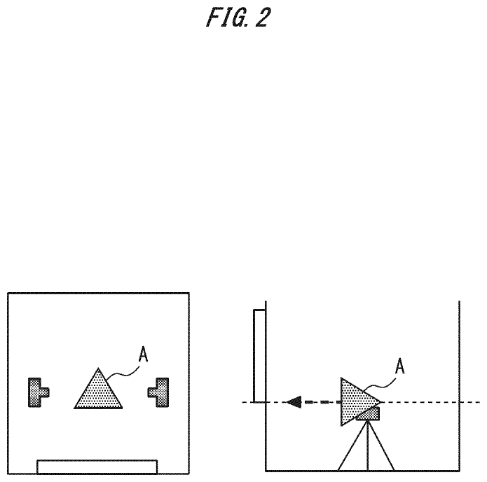

Subsequently, the 3D data input unit A is explained with reference to FIG. 2.

FIG. 2 is a diagram for explaining the 3D data input unit A of the processing system to which the elevator 3D data processing device in the first embodiment is applied.

In FIG. 2, for example, the 3D data input unit A is a 3D measurement sensor. For example, 3D data input unit A is a laser scanner. For example, the 3D data input unit A is an RGBD camera. For example, the 3D data input unit A obtains a 3D point group of a shaft of an elevator in a state in which the 3D data input unit A is temporarily installed in the shaft. For example, the 3D data input unit A joins 3D point groups obtained at moving points in time to obtain a 3D point group of the shaft with a technique such as SLAM (Simultaneously Localization and Mapping) while moving together with a car of the elevator. For example, the 3D data input unit A joins, offline, point groups obtained by different two or more measurement trials to obtain a 3D point group of the shaft.

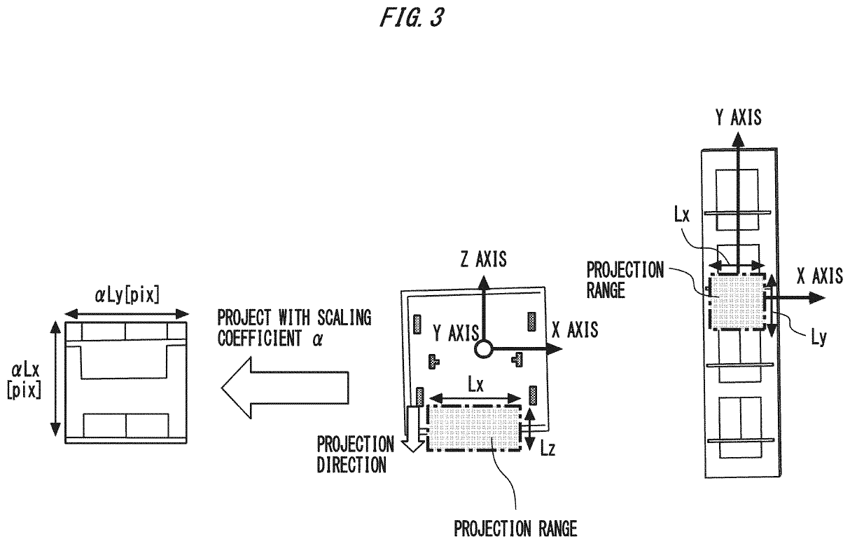

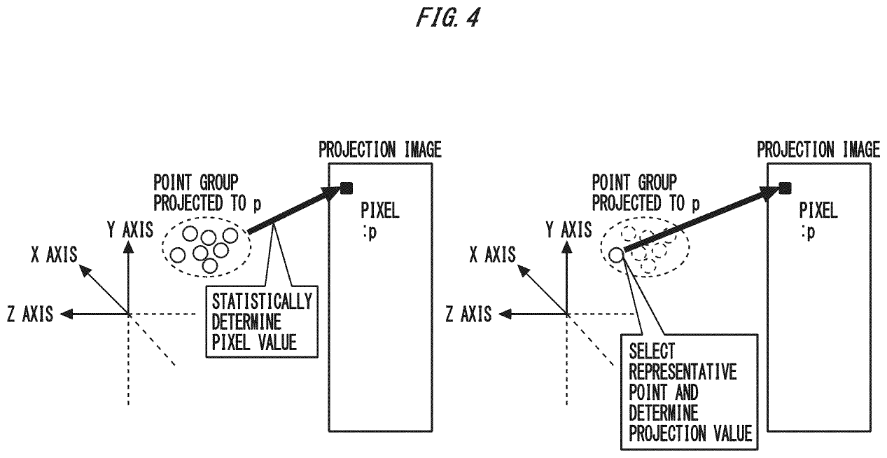

Subsequently, the reference straight line extracting unit 2 and the first aligning unit 3 are explained with reference to FIG. 3 to FIG. 7. FIG. 3 is a diagram for explaining the reference straight line extracting unit and the first aligning unit of the elevator 3D data processing device in the first embodiment. FIG. 4 to FIG. 7 are diagrams for explaining the reference straight line extracting unit of the elevator 3D data processing device in the first embodiment.

The reference straight line extracting unit 2 extracts a reference straight line for aligning the 3D point group of the shaft according to any one axis among an X axis, a Y axis, and a Z axis.

For example, as shown in FIG. 3, the reference straight line extracting unit 2 extracts a boundary line between a landing sill and a hatch door as the reference straight line. Specifically, the reference straight line extracting unit 2 generates a projection image of the periphery of a landing sill of a certain floor. For example, the reference straight line extracting unit 2 sets a plane parallel to an XY plane as a projection surface and generates a projection image obtained by projecting, onto the projection surface, a point group present in a range in which a Z coordinate value is minus.

When a size of a projection area is represented as a size (in a shaft lateral width direction) Lx [m] of the projection area in the X-axis direction, a size (in a shaft height direction) Ly [m] in the Y-axis direction, and a size (in a shaft depth direction) Lz [m] in the Z-axis direction, the reference straight line extracting unit 2 determines a size of the projection image as width: αLx [pix] and height: αLy [pix]. Here, α is a scaling coefficient at a projection time.

For example, when the scaling coefficient a and the sizes Lx, Ly, and Lz of the projection area are determined beforehand and a setting position at a measurement time of the 3D data input unit A substantially coincides with the center of the shaft and the center of the 3D data input unit A substantially coincides with the height of the landing sill, the reference straight line extracting unit 2 regards each of center X and Y coordinates Cx and Cy of the projection area as 0 and determines only the remaining Cz based on information concerning a bounding box of a point group.

Specifically, the reference straight line extracting unit 2 calculates a bounding box targeting a point group obtained by applying down-sampling, noise removal processing, and the like to a measured point group and calculates a minimum value of a Z coordinate value. In the structure of the shaft, the vicinity of the minimum value of the Z coordinate value is a wall surface or the hatch door. Therefore, the reference straight line extracting unit 2 sets, as Cz, a Z coordinate value increased from the minimum value of the Z coordinate value by a margin decided beforehand.

For example, as a method not depending on the setting position at the measurement time of the 3D data input unit A, when α, Lx, Ly, and Lz are determined beforehand, the reference straight line extracting unit 2 determines positions of Cx, Cy, and Cz by urging a user to optionally designating point group data presented through a point group display device not shown in FIG. 3.

When an original point group has color information and a projection image is a color image, the reference straight line extracting unit 2 directly adopts, as a pixel value, an RGB value of a point serving as a projection source. For example, when the projection image is a gray scale image, the reference straight line extracting unit 2 adopts, as a pixel value, a value obtained by converting the RGB value into a gray scale. For example, the reference straight line extracting unit 2 adopts a value of a Z coordinate value as a pixel value. For example, when the original point group has a gray scale value like a reflection intensity value of a laser, the reference straight line extracting unit 2 adopts the gray scale value as a pixel value. For example, the reference straight line extracting unit 2 separately creates each of the illustrated plurality of pixel values.

As shown in FIG. 4, in the case of a specific pixel of a projection image of a plurality of point groups, the reference straight line extracting unit 2 determines a pixel value of the pixel from statistical amounts of pixel values of the plurality of point groups. For example, the reference straight line extracting unit 2 sets an average value of RGB values of the plurality of point groups as the pixel value of the pixel. For example, the reference straight line extracting unit 2 selects a point of a coordinate, a Z coordinate value of which is the closest to the origin, as a representative point and sets a pixel value of the coordinate as the pixel value of the pixel.

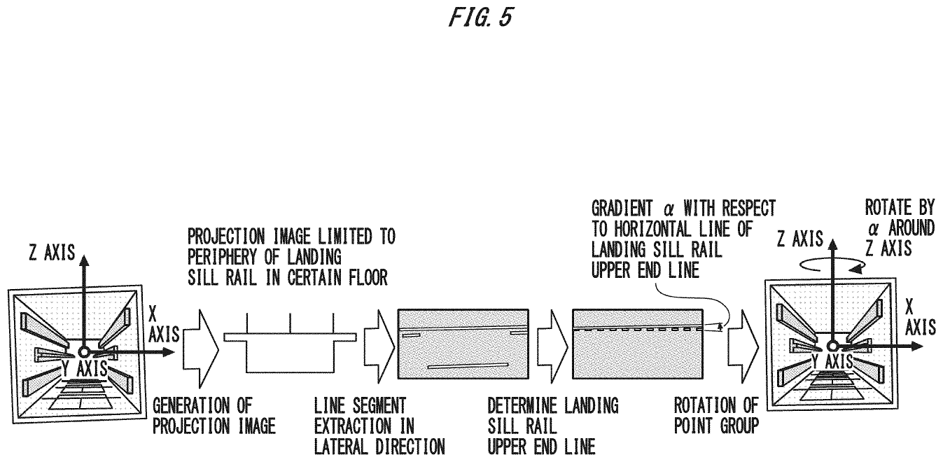

For example, as shown in FIG. 5, the reference straight line extracting unit 2 extracts a boundary line between the landing sill and the hatch door with edge detection processing in the horizontal direction on a projection image.

For example, the reference straight line extracting unit 2 applies an edge detector in the horizontal direction to the projection image to detect an edge. The reference straight line extracting unit 2 extracts the boundary line between the landing sill and the hatch door by applying a straight line model to an edge image with RANSAC (Random Sample Consensus) or the like.

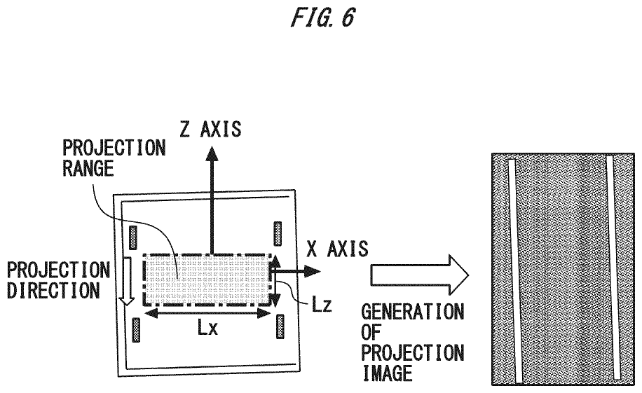

For example, as shown in FIG. 6, the reference straight line extracting unit 2 extracts a reference straight line from a linear structure extending in the vertical direction such as a car rail or a vertical column.

When the car rail is set as the reference straight line, assuming that the setting position at the measurement time of the 3D data input unit A is substantially the shaft center, the scaling coefficient a and the length (Lz) in the Z-axis direction of the projection area are determined beforehand. Lx is determined based on an inter-car rail distal end distance (BG) from a drawing at a new installation time. For example, Lx is a value obtained by adding a margin width to BG. Ly is determined based on the length in a Y direction of a bounding box of a point group from which noise is removed. For example, Ly is a value obtained by subtracting the margin width from the length in the box Y direction. Cx and Cz in the center of the area are set to 0. Cy is set to a center Y coordinate of the bounding box of the point group from which noise is removed.

The reference straight line extracting unit 2 generates a projection image by projecting a point group in the projection range onto a projection surface parallel to the XY plane. For example, the reference straight line extracting unit 2 generates a projection image with a projection direction set in a plus direction of the Z axis. For example, the reference straight line extracting unit 2 generates a projection image with the projection direction set in a minus direction of the Z axis.

Note that the reference straight line extracting unit 2 may determine Cx, Cy, and Cz by urging the user to optionally designate point group data presented through the point group display device.

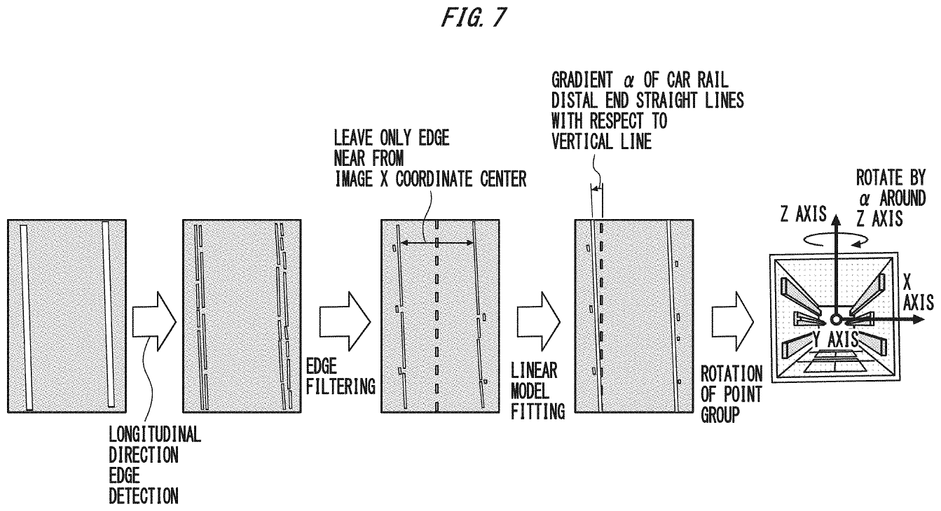

As shown in FIG. 7, the reference straight line extracting unit 2 extracts straight lines equivalent to the distal ends of left and right car rails with edge detection processing in the vertical direction on a projection image.

For example, the reference straight line extracting unit 2 applies an edge detector in the vertical direction to the projection image to detect an edge. For example, the reference straight line extracting unit 2 extracts an edge equivalent to each of the distal ends of the left and right car rails by performing filtering for leaving only an edge closest to each of the plus direction and the minus direction from a projection image X coordinate center. At this time, the reference straight line extracting unit 2 applies a linear model to an edge image with RANSAC or the like to extract a straight line.

At this time, the reference straight line extracting unit 2 only has to extract at least one of straight lines equivalent to the left and right car rails. The reference straight line extracting unit 2 may extract both of the straight lines as a set of parallel straight lines in a pairwise manner.

Note that the reference straight line extracting unit 2 may perform preprocessing such as noise removal processing by a median filter, expansion processing, contraction processing, or the like or edge coupling processing before linear model fitting. The reference straight line extracting unit 2 may extract a straight line with Hough transform. When a plurality of types are present in the projection image, the reference straight line extracting unit 2 may extract a straight line according to a plurality of kinds of edge information. For example, when a projection image having an RGB value of a point group as a pixel value and a projection image having a Z coordinate value as a pixel value are present, the reference straight line extracting unit 2 may detect edges from both the projection images and extract straight lines according to both pieces of edge information.

The first aligning unit 3 converts a coordinate such that the reference straight line becomes parallel to any axis of an XYZ coordinate system with respect to the point group data.

For example, when a landing sill upper end line is extracted as the reference straight line, the first aligning unit 3 calculates an angle a formed by the landing sill upper end line detected from a projection image and an image horizontal line and rotates the original point group data in the opposite direction by a around the Z axis.

For example, as shown in FIG. 3, when a left or right distal end straight line of the car rail is extracted as the reference straight line, the first aligning unit 3 calculates an angle a formed by the left or right distal end straight line detected from the projection image and an image vertical line and rotates the original point group data in the opposite direction by α around the Z axis.

For example, when left and right car rail distal end straight lines are separately extracted on the left and the right, the first aligning unit 3 calculates an average of angles α1 and α2 formed by the respective car rails with the image vertical line and rotates the original point group data in the opposite direction by an average angle of α1 and α2 around the Z axis.

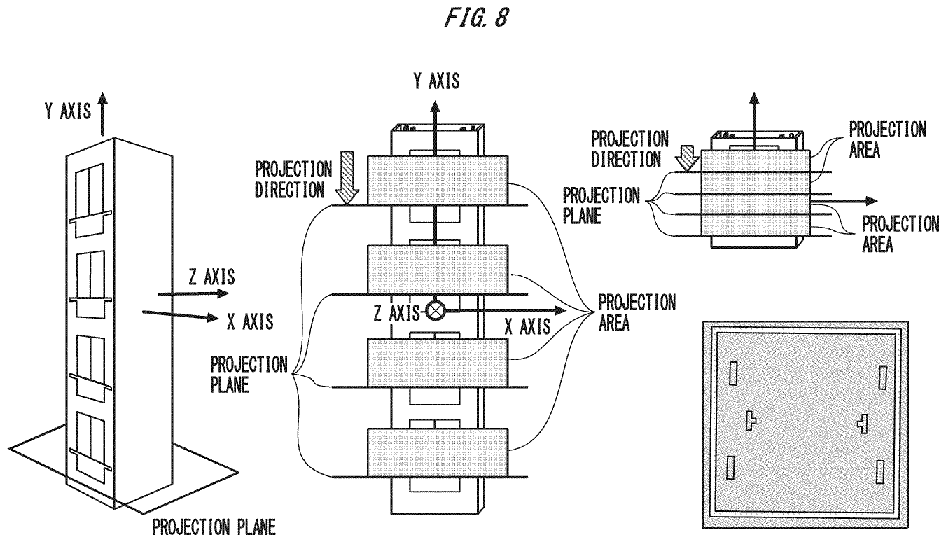

Subsequently, the reference plane extracting unit 4 is explained with reference to FIG. 8 to FIG. 11. FIG. 8 to FIG. 11 are diagrams for explaining the reference plane extracting unit of the elevator 3D data processing device in the first embodiment.

The reference plane extracting unit 4 extracts a plane for alighting 3D data of the shaft concerning the remaining two axes not set as a reference of alignment in the reference straight line. For example, the reference plane extracting unit 4 extracts a plane connecting the distal ends of the left and right car rails as a reference plane.

As shown in FIG. 8, the reference plane extracting unit 4 sets an imaginary projection surface on which the horizontal axis and the vertical axis of an image in a ceiling direction or a bottom surface direction of the shaft are parallel to the X axis and the Z axis of the 3D coordinate system. The reference plane extracting unit 4 generates a projection image in the same manner as the reference straight line extracting unit 2. At this time, the reference plane extracting unit 4 generates a plurality of projection images according to a Y-axis value of the 3D coordinate system. For example, the reference plane extracting unit 4 generates a projection image for each of projection target areas having a preset size at a preset interval from the top to the bottom of point group data.

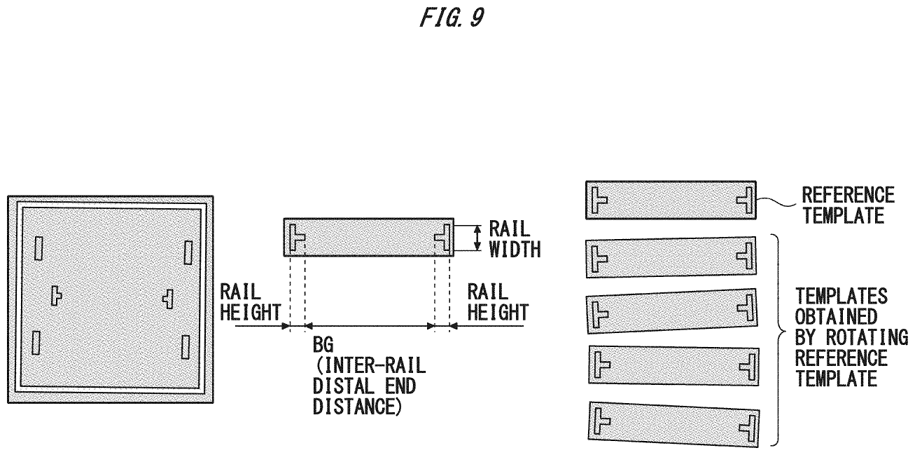

As shown in FIG. 9, the reference plane extracting unit 4 extracts left and right car rail distal end positions in a pairwise manner with respect to the respective projection images. For example, the reference plane extracting unit 4 extracts the left and right car rail distal end positions in a pairwise manner based on pattern features on the projection images of the car rails.

A standard of the car rails and a distance between the car rails are obtained from prior information. Therefore, the reference plane extracting unit 4 creates pairwise model images based on ideal views of the respective left and right car rails appearing in the projection images.

The reference plane extracting unit 4 performs, on the respective projection images, template matching using the model images of the left and right car rails as a reference plate. At this time, the reference plane extracting unit 4 not only changes only a position of the template but also rotates the template within a preset range to perform the template matching. For example, the reference plane extracting unit 4 scans the reference template to perform a coarse search and performs a dense search using the template rotated near a matching position of the coarse search.

Note that the reference plane extracting unit 4 may create model images separately for the left and the right.

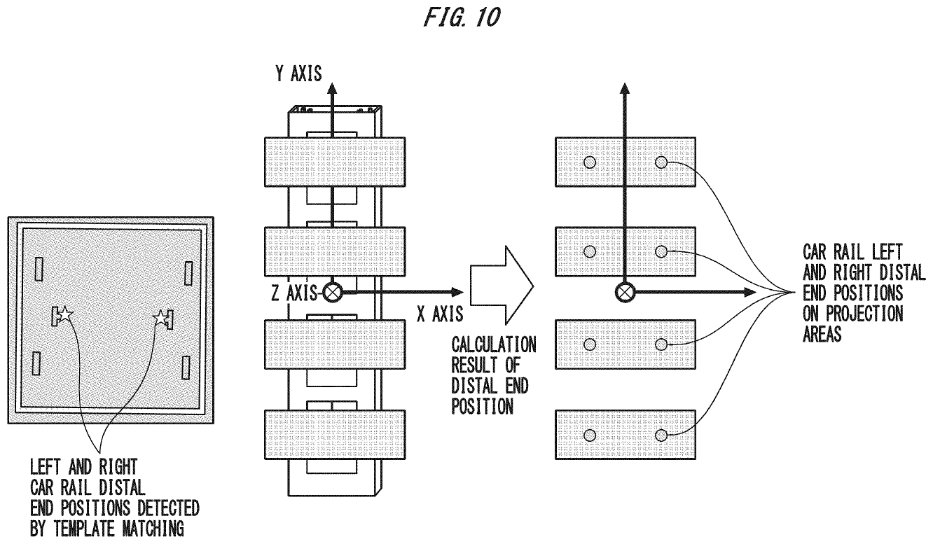

As shown in FIG. 10, the reference plane extracting unit 4 calculates, based on positions and rotation angles of the template on the respective projection images, positions on the projection images of matched distal end positions of the left and right car rails. At this time, the reference plane extracting unit 4 calculates positions on the projection images of the matched distal end positions of the left and right car rails by originally defining left and right rail distal end positions in a template image.

The reference plane extracting unit 4 calculates coordinates of the distal ends of the left and right car rails on the 3D coordinate. At this time, the reference plane extracting unit 4 determines Y coordinate values of the distal ends of the left and right car rails based on height of an original projection area. For example, the reference plane extracting unit 4 adopts an intermediate Y coordinate value of the original projection area as the Y coordinate values of the distal ends of the left and right car rails.

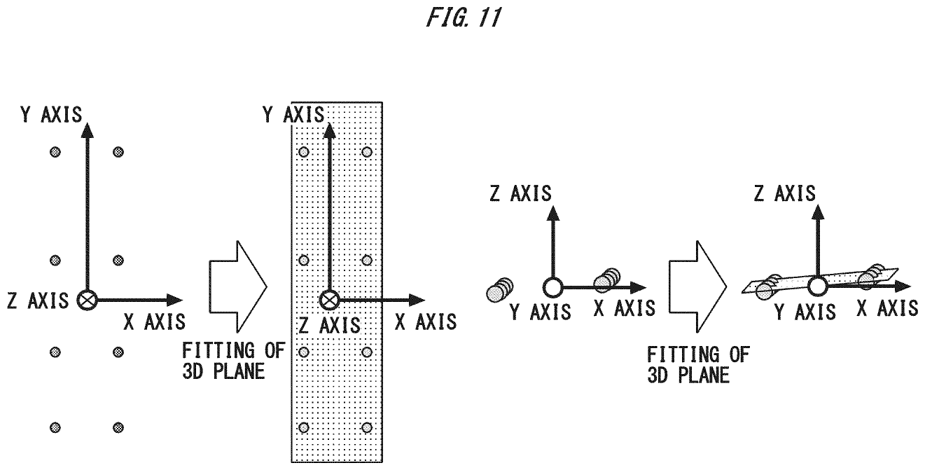

For example, as shown in FIG. 11, the reference plane extracting unit 4 obtains 2K 3D positions as the distal end positions of the left and right car rails by performing the same processing on K projection images. The reference plane extracting unit 4 performs 3D plane model fitting on the 2K 3D positions. For example, the reference plane extracting unit 4 estimates a 3D plane with the method of least squares. The reference plane extracting unit 4 extracts a reference plane as a plane using the estimated 3D plane as a plane connecting the distal ends of the left and right car rails.

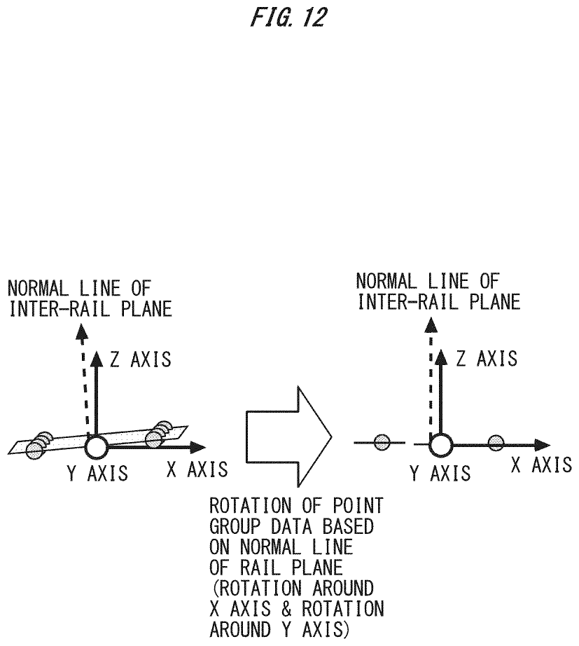

Subsequently, the second aligning unit 5 is explained with reference to FIG. 12. FIG. 12 is a diagram for explaining the second aligning unit of the elevator 3D data processing device in the first embodiment.

The second aligning unit 5 aligns point group data by rotating the point group data about a rotation axis about which the point group data is not rotated by the first aligning unit 3 such that the normal line of the reference plane becomes parallel to any one axis of the X axis, the Y axis, and the Z axis.

For example, in a state in which the first aligning unit 3 is performing rotation based on the upper end line of the landing sill and when the plane between the distal ends of the left and right car rails is set as the reference plane, as shown in FIG. 12, the second aligning unit 5 aligns the point group data by rotating the point group data around the X axis and the Y axis such that the normal line of the reference plane becomes parallel to the Z-axis direction.

Note that the extraction of the reference straight line by the reference straight line extracting unit 2 to the alignment of the point group data by the second aligning unit 5 may be repeated.

The reference plane extracting unit 4 may extract the reference plane first. In this case, the first aligning unit 3 only has to align the 3D data of the shaft according to the reference plane extracted by the reference plane extracting unit 4. Thereafter, the reference straight line extracting unit 2 only has to extract the reference straight line of the shaft from the 3D data aligned by the first aligning unit 3. Thereafter, the second aligning unit 5 only has to align the 3D data aligned by the first aligning unit 3 according to the reference straight line extracted by the reference straight line extracting unit 2.

At this time, the reference plane extracting unit 4 may extract a reference plane having a normal line parallel to any one of the X axis, the Y axis, and the Z axis of the XYZ coordinate system. The reference straight line extracting unit 2 may extract a reference straight line orthogonal to the normal line of the plane extracted by the reference plane extracting unit.

For example, the reference plane extracting unit 4 may extract, as a reference plane, a plane parallel to a plane connecting linear distal ends of a pair of car rails. For example, the reference straight line extracting unit 2 may extract, as a reference straight line, a straight line parallel to the boundary line between the landing sill and the hatch door.

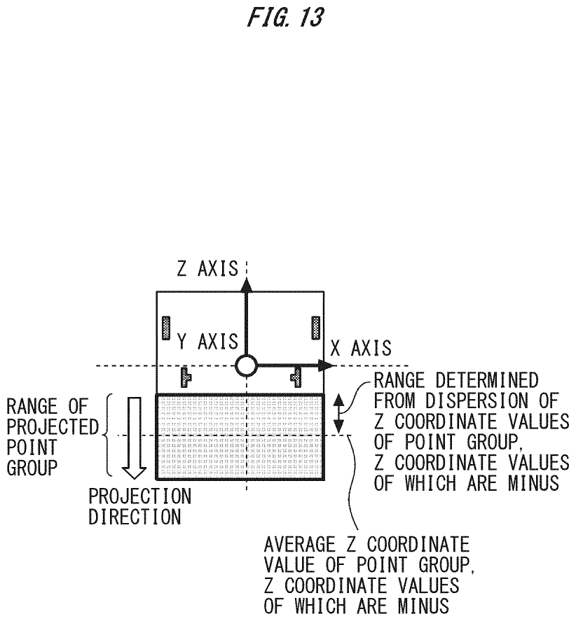

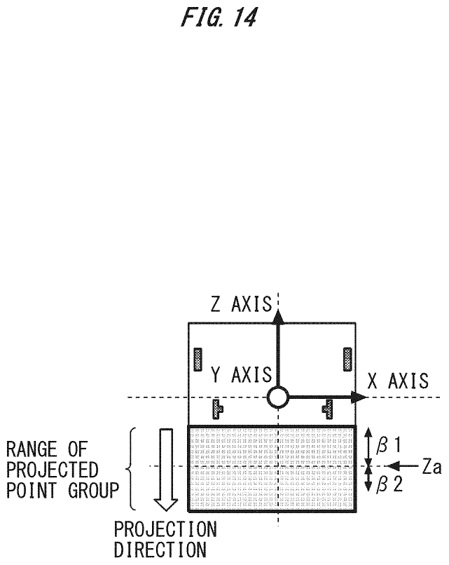

Subsequently, the projection image generating unit 6 is explained with reference to FIG. 13 to FIG. 15.

FIG. 13 to FIG. 15 are diagrams for explaining the projection image generating unit of the elevator 3D data processing device in the first embodiment.

As shown in FIG. 13, the projection image generating unit 6 decides, as a 2D projection surface, any one wall surface direction among directions of a wall surface on a hall side, a left wall surface, a right wall surface, a rear wall surface, and a bottom surface of the shaft.

For example, a size of a projection image is determined from a bounding box surrounding entire point group data. For example, the size of the projection image is determined by a value decided beforehand.

For example, the projection image generating unit 6 calculates a bounding box for the point group data to which down-sampling and noise removal processing are applied. When a size in the X-axis direction is Lx [m], a size in the Y-axis direction is Ly [m], and a size in the Z-axis direction is Lz [m] in the bounding box, the projection image generating unit 6 sets width of a projection image having a hall direction as a projection direction to αLx [pix] and sets height of the projection image to αLy [pix]. Here, α is a scaling coefficient at a projection time.

For example, a range of point group data for performing projection is determined based on a coordinate value in an axial direction. In projection to the hall side wall surface, only a point group, Z-axis coordinate values of which are minus, is set as a projection target. If the range is further narrowed, for example, a point group, Z coordinate values of which are in a range of Za+β1 [mm] to Za−β2 [mm], in the point group, the Z-axis coordinate values of which are minus, is set as a projection target.

For example, Za is decided beforehand. For example, Za is decided by an intermediate value or an average value of Z coordinate values. For example, β1 and β2 are decided beforehand. For example, β1 and β2 are dynamically decided from a statistical amount such as dispersion of Z coordinate values of a point group, the Z coordinate values of which are minus. For example, projection targets of X coordinate values and Y coordinate values are narrowed down based on a preset sill.

A projection image at this time is the same projection image as that of FIG. 4.

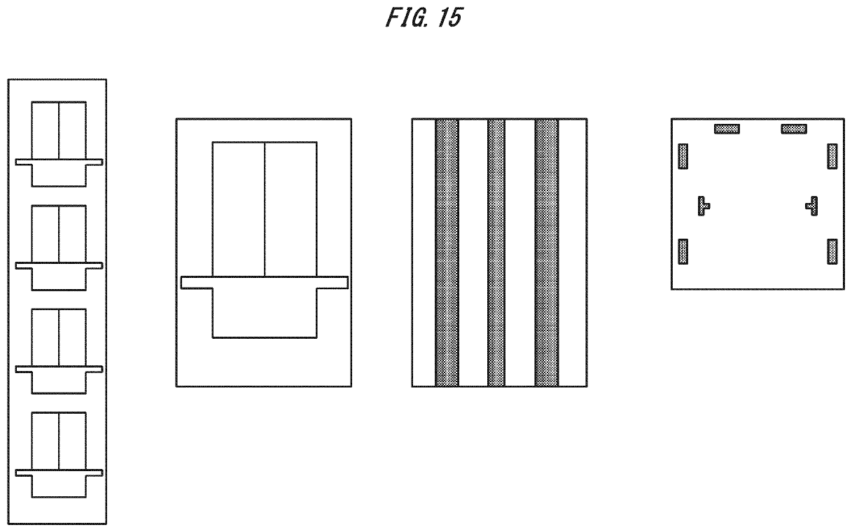

As shown in FIG. 15, the projection image is an image facing the directions of the wall surface on the hall side, the left wall surface, the right wall surface, the rear wall surface, and the bottom surface of the shaft when the center of the shaft is set as a visual point.

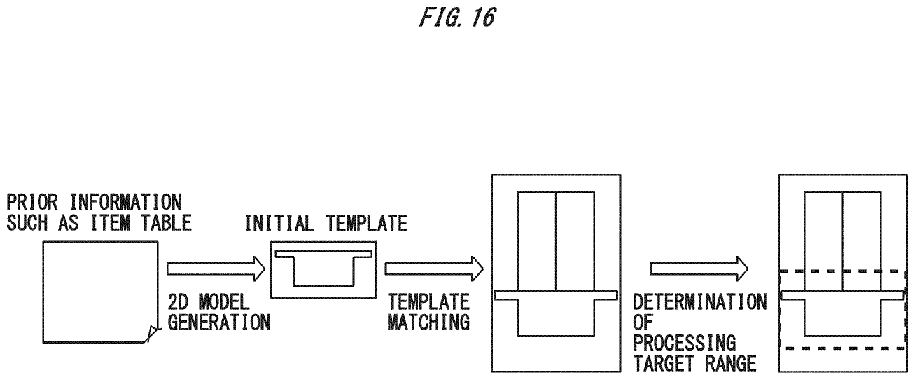

Subsequently, the projection image feature extracting unit 7 is explained with reference to FIG. 16 to FIG. 25. FIG. 16 to FIG. 25 are diagrams for explaining the projection image feature extracting unit of the elevator 3D data processing device in the first embodiment.

The projection image feature extracting unit 7 extracts feature of a target serving as a start point of a dimension that should be calculated from a projection image.

For example, the projection image feature extracting unit 7 extracts an upper end line of the landing sill from a projection image to the wall surface on the hall side. The projection image feature extracting unit 7 extracts the upper end line of the landing sill with the same method as the method of the reference straight line extracting unit 2.

When the upper end line of the landing sill is already extracted, the projection image feature extracting unit 7 may omit the extraction processing or may perform the extraction processing again.

When original point group data is formed from point group data of a single floor, the projection image feature extracting unit 7 sets a processing target range in order to specify an approximate position of the landing sill from the viewpoint of erroneous detection prevention.

When the configurations, the sizes, and the like of parts configuring the landing sill are known from an item table or the like, as shown in FIG. 16, the projection image feature extracting unit 7 creates, as an initial template, a 2D pattern characterizing a shape structure near the landing sill. The projection image feature extracting unit 7 scans the initial template on the projection image to perform template matching and sets, as the processing target range, the vicinity of a position matching most. For example, the projection image feature extracting unit 7 sets, as the processing target range, a rectangle centering on the matching position and having the same size as the initial template or a size obtained by adding a margin width to the initial template. When there is no prior information, for example, the projection image feature extracting unit 7 sets, as the processing target range, an intermediate area at the time when an image is divided into three in the longitudinal direction or sets, as the processing target range, a lower area at the time when the image is divided into two in the longitudinal direction. When an approximate position of the landing sill is calculated, the projection image feature extracting unit 7 sets the processing target range reusing information concerning the position of the landing sill.

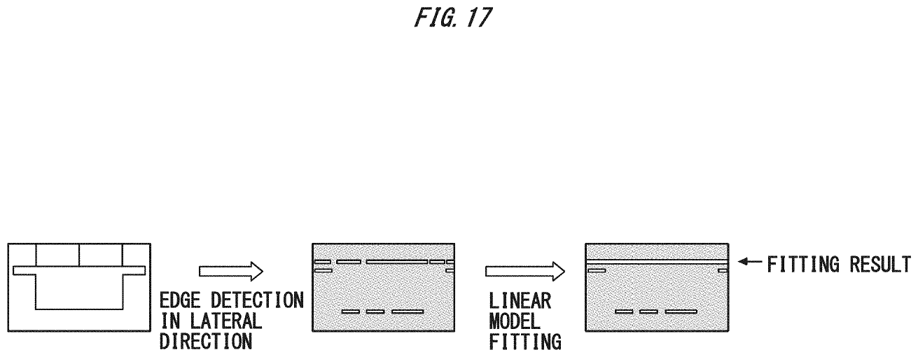

As shown in FIG. 17, the projection image feature extracting unit 7 applies an edge detector in the horizontal direction to the processing target range to detect an edge in the lateral direction and applies a horizontal line model using RANSAC or the like to an edge image to extract one horizontal line.

Note that the projection image feature extracting unit 7 may perform preprocessing such as noise removal processing by a median filter, expansion processing, contraction processing, or the like or edge coupling processing before linear model fitting. The projection image feature extracting unit 7 may extract a straight line with Hough transform. When a plurality of types are present in the projection image, the projection image feature extracting unit 7 may extract a straight line according to a plurality of kinds of edge information. For example, when a projection image having an RGB value of a point group as a pixel value and a projection image having a Z coordinate value as a pixel value are present, the projection image feature extracting unit 7 may detect edges from both the projection images and extract straight lines according to both pieces of edge information.

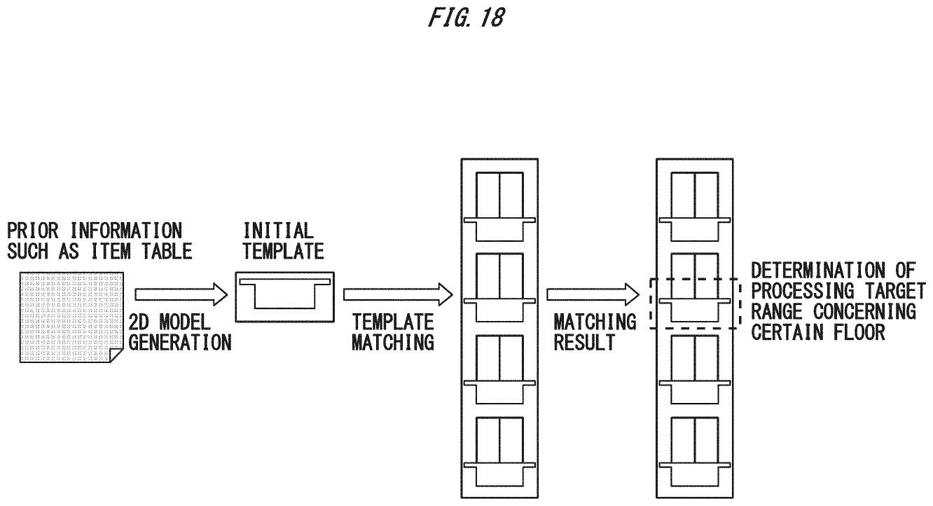

When a projection image is formed from projection images of a plurality of floors, as shown in FIG. 18, the projection image feature extracting unit 7 narrows down the plurality of floors to one floor and extracts an upper end line of a landing fill.

The projection image feature extracting unit 7 creates the same initial template as the initial template in the case of the single floor. The projection image feature extracting unit 7 sets a processing target area around a landing sill of a certain floor by matching the initial template with a projection image. At this time, a scanning range of the initial template may be the entire projection image or the projection image feature extracting unit 7 may narrow down ranges obtained by equally dividing the projection image in the longitudinal direction and sets any one of the ranges as the scanning range.

As in the case of the single floor, the projection image feature extracting unit 7 extracts, by performing the linear model fitting or the like in the horizontal direction on a processing target area around a landing fill of a certain floor, an upper end line of the landing sill of the floor.

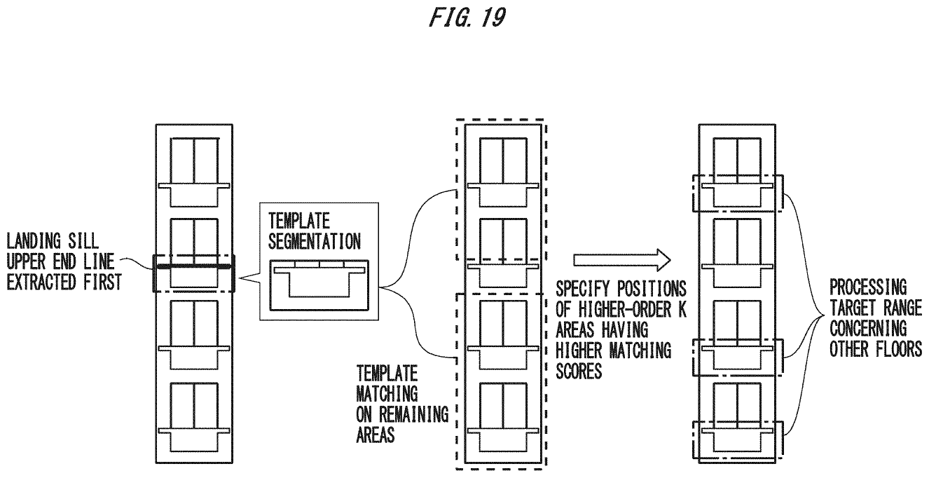

As shown in FIG. 19, the projection image feature extracting unit 7 sets, based on a position of a landing sill upper end line detected first, upper end line detection ranges of landing sills in the remaining floors. For example, the projection image feature extracting unit 7 extracts, based on the landing sill upper end line detected first, as a template, a texture pattern itself of a rectangular area having a preset size and specifies, with the template matching, processing target areas concerning the remaining floors.

For example, when the number of floors is K, the projection image feature extracting unit 7 scans the template on areas other than the area extracted as the template and determines higher-order K-1 areas having higher matching scores as processing target areas of the remaining floors. At this time, the projection image feature extracting unit 7 considers spatial proximity of matching positions rather than simply selecting the higher-order K-1 areas. For example, when there are L matching positions having excessively short spatial distances to a certain matching position among the higher-order K-1 areas, the projection image feature extracting unit 7 adopts only a position having the highest matching score as a result and excludes the remaining (L-1) areas from selection.

The projection image feature extracting unit 7 adopts, anew, matching positions initially having K to K-1+(L-1)-th score levels. The projection image feature extracting unit 7 finally determines K-1 matching positions by repeating the processing until there is no matching position having excessively short spatial distances to all the matching positions.

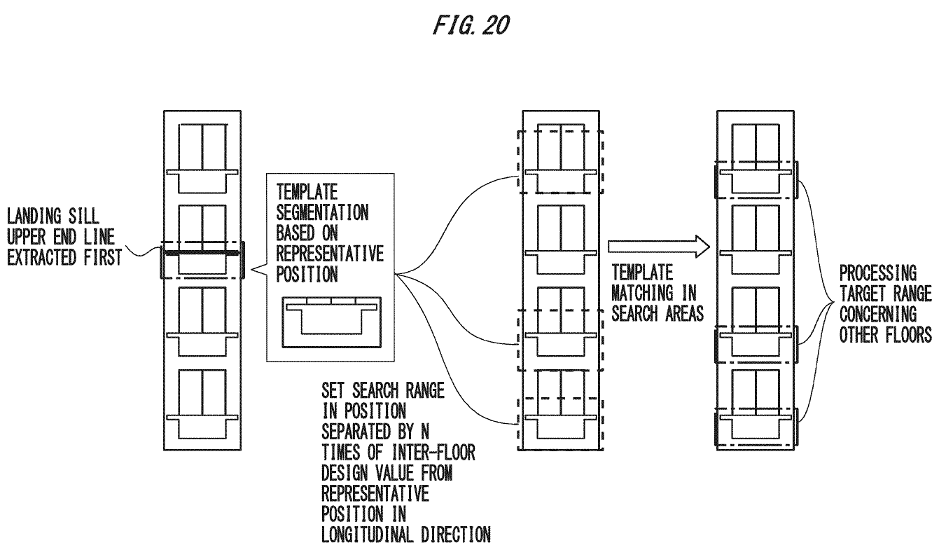

When an inter-floor distance of the shaft set as a target is roughly known from a drawing or the like at a new installation time, the projection extracting unit reduces a range of the template matching and reduces a calculation time by utilizing prior information, suppresses wrong handling of the template, and improves robustness of a result by using prior information. Specifically, as shown in FIG. 20, the projection image feature extracting unit 7 sets, based on a landing sill upper end line extracted first, a scanning range having, as a center position, a position separated in the longitudinal direction of a projection image by length of a value obtained by scaling an inter-floor design value to length on the projection image.

After setting the processing target areas concerning the other floors, the projection image feature extracting unit 7 performs, on the respective processing target areas, the same linear model fitting or the like based on edge detection in the lateral direction as the linear model fitting or the like in the case of the single floor and extracts upper end lines of landing sills concerning the respective floors.

Note that the projection image feature extracting unit 7 may apply a general linear (ax+by+c=0) model and extracts an upper end line of a landing sill as a straight line having a gradient.

The projection image feature extracting unit 7 extracts distal end positions of the left and right car rails from the projection image in the bottom surface direction like the reference plane extracting unit 4. When the reference plane extracting unit 4 is extracting a distal end position of a left guide rail, the projection image feature extracting unit 7 may omit the extraction processing or may perform the extraction processing again.

The projection image feature extracting unit 7 extracts left and right end lines of vertical columns from the projection image to the left and right wall surfaces or the rear wall surface.

In aligned point group data, the vertical columns are parallel to the Y axis. On the projection image, the left and right end lines of the vertical columns appear as vertical lines.

The projection image feature extracting unit 7 detects a relatively long straight line among straight lines in the longitudinal direction extracted from the projection image.

On the other hand, on the shaft left and right wall surfaces, since cables and the like positioned along the car rails and the walls are present, a large number of vertical edges by other structures appear as noise on the projection image. The projection image feature extracting unit 7 suppresses the influence of the noise and extracts the left and right end lines of the vertical columns.

Note that, even if the vertical columns are H steel, the vertical columns can be treated the same by this method.

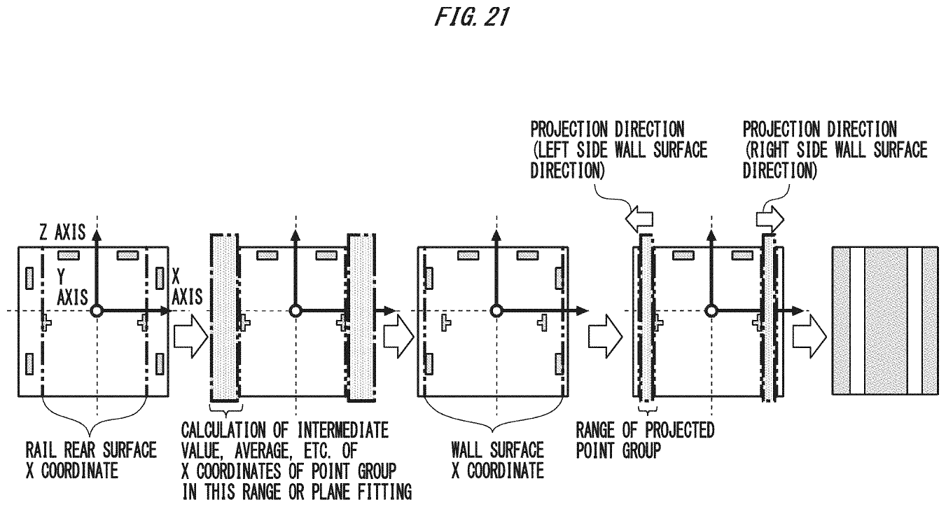

As shown in FIG. 21, the vertical columns located in the front of the left and right wall surfaces are present in positions slightly apart from the wall surfaces of the shaft and are present between the car rails and the wall surfaces. In the aligned point group data, the projection images in the left and right wall surface directions are projection images to the X-axis plus (the right side wall surface) and the X-axis minus (the left side wall surface). Therefore, the projection image feature extracting unit 7 generates a projection image obtained by extracting point groups equivalent to the vertical columns by narrowing down a range of a projected point group from a range of rear surface position X coordinates of the car rails to X coordinates of the wall surfaces further considering a margin.

The margin only has to be set beforehand and may be set based on a distance measurement error characteristic of the 3D data input unit A. The rear surface position X coordinates of the car rails are estimated from standard information of the car rails if the distal end positions of the car rails are extracted. X coordinates of planes equivalent to the wall surfaces are calculated from an intermediate value, an average value, and the like of all X coordinate values concerning point groups present in farther positions than the car rail rear surface position X. Plane fitting may be performed on these partial point groups.

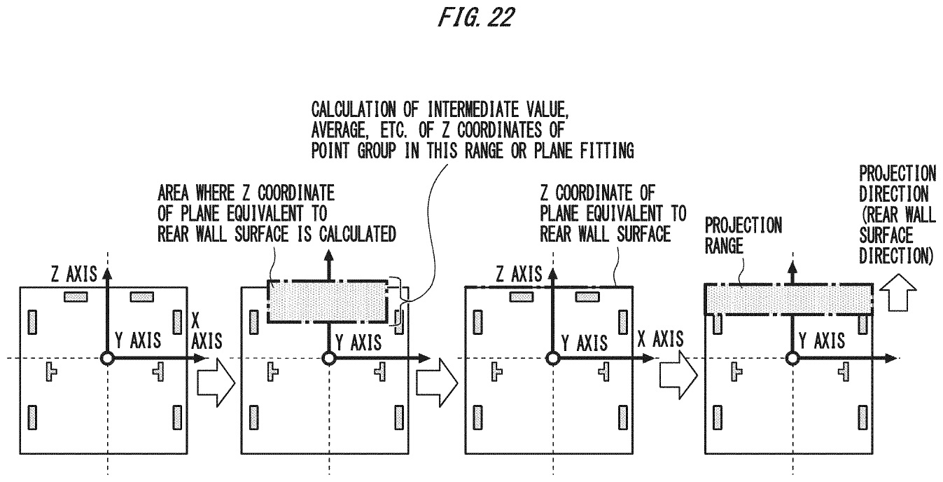

As shown in FIG. 22, the vertical columns located in the front of the rear wall surface are present in positions slight apart from the wall surface of the shaft. In the aligned point group data, the projection image in the rear wall surface direction is a projection image in the Z-axis plus direction. Therefore, the projection image feature extracting unit 7 generates a projection image obtained by extracting point groups equivalent to the vertical columns by narrowing down a range of Z coordinate values of a projected point group from a range from a Z coordinate of the wall surface to a Z coordinate—a constant α of the wall surface further considering a margin. The margin only has to be set beforehand and may be set based on a distance measurement error characteristic of a sensor.

The projection image feature extracting unit 7 decides a range for calculating a Z coordinate of a plane equivalent to the rear wall surface from circumscribed rectangle information or the like of a point group and calculates the Z coordinate of the plane equivalent to the rear wall surface from an intermediate value, an average value, and the like of Z coordinates concerning point groups in the range.

Note that the constant α may be determined based on width in the case in which the vertical columns are set most apart from the wall surface in the vertical column setting positions estimated from a general construction standard or the like or a value estimated from the drawing at the new installation time may be set as the constant α .

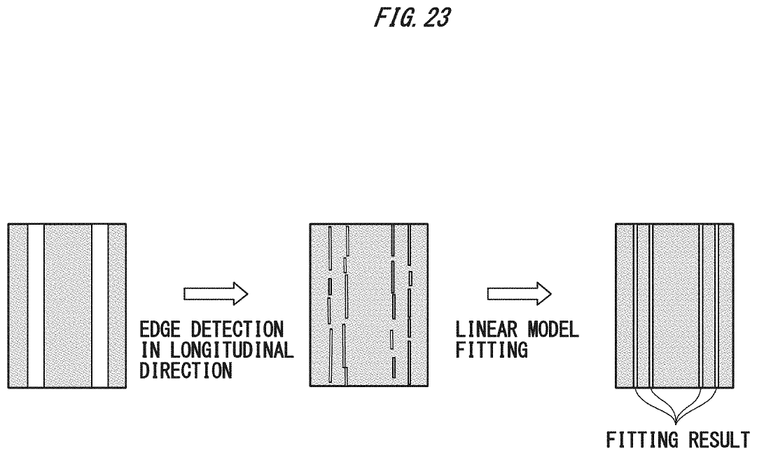

As shown in FIG. 23, the projection image feature extracting unit 7 applies an edge detector in the vertical direction to the projection image narrowed down to the vertical columns to detect an edge in the vertical direction. The projection image feature extracting unit 7 applies a vertical linear model using RANSAC or the like to an edge image to extract a straight line.

Note that the projection image feature extracting unit 7 may extract a straight line as a model of a set of vertical parallel lines.

Note that the projection image feature extracting unit 7 may perform preprocessing such as noise removal processing by a median filter, expansion processing, contraction processing, or the like or edge coupling processing before linear model fitting. The projection image feature extracting unit 7 may extract a straight line with Hough transform. When a plurality of types are present in the projection image, the projection image feature extracting unit 7 may extract a straight line according to a plurality of kinds of edge information. For example, when a projection image having an RGB value of a point group as a pixel value and a projection image having a Z coordinate value as a pixel value are present, the projection image feature extracting unit 7 may detect edges from both the projection images and extract straight lines according to both pieces of edge information.

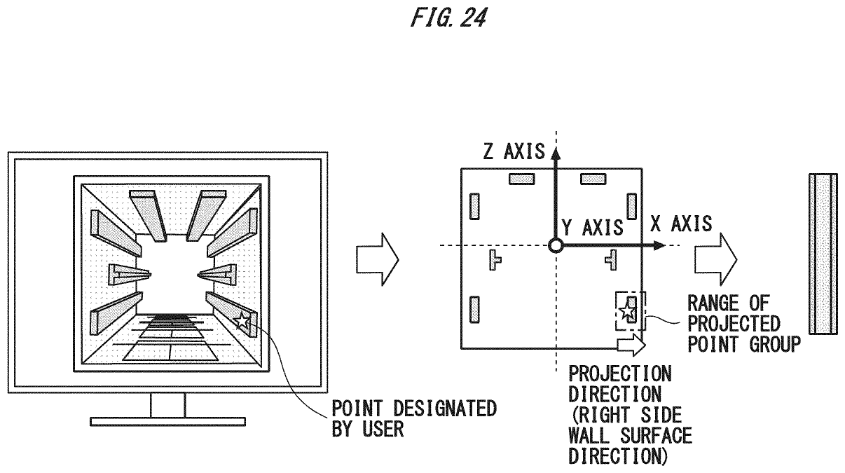

As shown in FIG. 24, via a display device for point group data, the projection image feature extracting unit 7 may urge the user to “select vertical column points” and cause the use to designate one point in a point group belonging to the vertical columns. The projection image feature extracting unit 7 may generate, for the point designated by the user, a projection image using a point group selection box in a preset range as a projection range. In this case, one projection image is required for one vertical column. Therefore, although processing efficiency in extracting all the vertical columns is deteriorated, since the projection range is limited, the vertical columns are more robust against noise and extracted accurately.

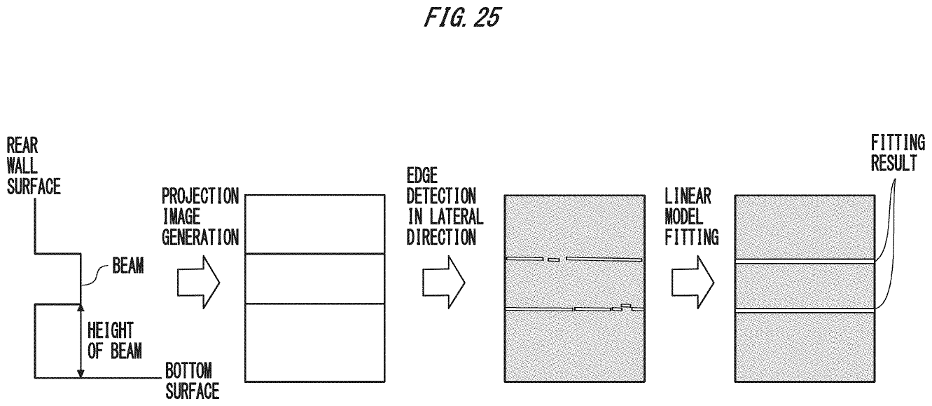

As shown in FIG. 25, in aligned point group data, the upper and lower ends of a beam are parallel to the X axis. On a projection image, the upper and lower ends of the beam appear as horizontal lines. The upper and lower ends of the beam appear as relatively long straight lines among straight lines in the lateral direction detected from the projection image. The projection image feature extracting unit 7 extracts the upper and lower ends of the beam by performing the same processing with the vertical direction changed to the horizontal direction in the extraction of the left and right ends of the vertical columns.

Note that, concerning a structure in which the left and right ends of the vertical columns, the upper and lower ends of the beam, and the like are detected as straight lines in the vertical direction or the horizontal direction on a projection image, all vertical lines and horizontal lines satisfying fixed conditions such as length and a gradient may be extracted from the projection image, as candidates. In this case, a group of these straight lines only has to be converted into a plane group in a 3D coordinate system and then presented to the user through a point group data display device. At this time, the user only has to select necessary straight lines through the point group data display device.

The reference position specifying unit 8 specifies positions serving as start points for calculating dimensions such as the upper end of the landing sill, the plane between the car rails, and the left and right ends of the vertical columns. For example, the reference position specifying unit 8 utilizes a extraction result of the projection image feature extracting unit 7 substantially as it is.

For example, the reference position specifying unit 8 converts landing sill upper end lines concerning the floors into an XYZ coordinate system on a projection image in the hall side wall surface direction. A dimension start point specifying unit calculates, as upper end planes of the landing sills, planes that pass straight lines and normal lines of which are orthogonal to the Z axis in the XYZ coordinate system. The dimension start point specifying unit sets the upper end planes of the landing sills concerning the floors as starts points of dimension calculation.

For example, the reference position specifying unit 8 extracts the distal end positions of the left and right car rails from a respective plurality of projection images. The reference position specifying unit 8 converts the distal end positions of the left and right car rails into an XYZ coordinate system. The reference position specifying unit 8 sets, as an inter-car rail plane, a result obtained by applying 3D plane fitting to a plurality of left and right car rail distal end positions on a 3D space. Note that, when an inter-car rail plane is already extracted, the extracted inter-car rail plane may be directly used.

Subsequently, the reference position specifying unit 8 is explained without referring to the drawings.

The reference position specifying unit 8 calculates average positions respectively for the left and right respective distal end positions in the XYZ coordinate system. The reference position specifying unit 8 sets the respective average positions as a left car rail distal end position and a right car rail distal end position. The reference position specifying unit 8 sets a plane passing the left car rail distal end position and orthogonal to the car rail plane as a left car rail distal end plane. The reference position specifying unit 8 sets a plane passing the right car rail distal end position and orthogonal to the car rail plane as a right car rail distal end plane. For example, the reference position specifying unit 8 sets these planes and positions as start points of dimension calculation.

For example, the reference position specifying unit 8 calculates planes that pass the straight lines and the normal lines of which are orthogonal to the X axis in the XYZ coordinate system as vertical column left and right end planes located in the front of the left and right wall surfaces. For example, the reference position specifying unit 8 calculates planes that pass the straight lines and the normal lines of which are orthogonal to the Z axis in the XYZ coordinate system as vertical column rear end planes located in the front of the rea wall surface. For example, the reference position specifying unit 8 sets the left and right end planes of the vertical columns as start points of dimension calculation.

For example, the reference position specifying unit 8 calculates planes that pass the straight lines and the normal lines of which are orthogonal to the X axis in the XYZ coordinate system as upper and lower end planes of beams located on the left and right wall surfaces or the rear wall surface. For example, the reference position specifying unit 8 sets the upper and lower end planes of the beams as start points of dimension calculation.

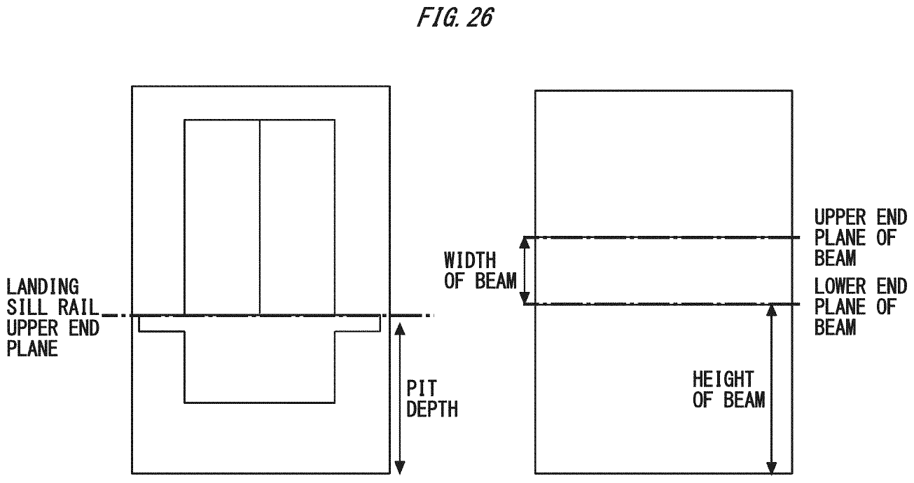

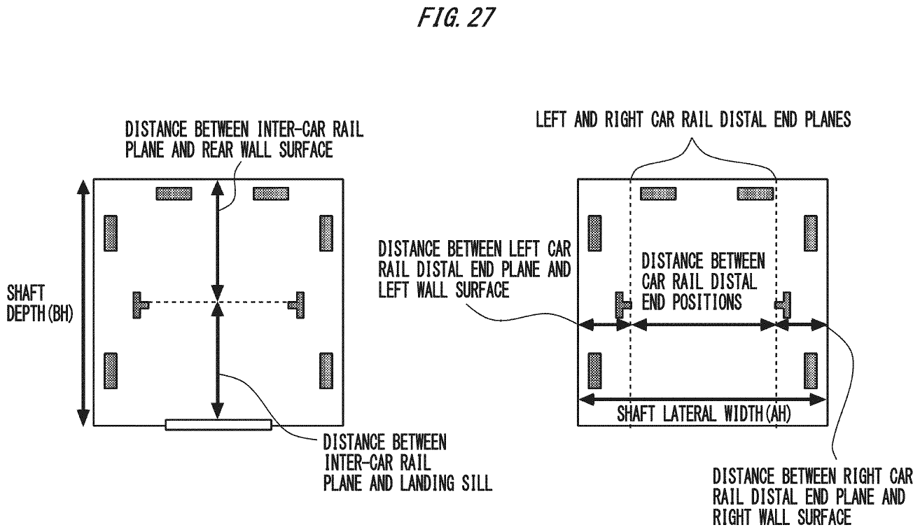

Subsequently, the dimension calculating unit 9 is explained with reference to FIG. 26 to FIG. 28.

FIG. 26 to FIG. 28 are diagrams for explaining the dimension calculating unit of the elevator 3D data processing device in the first embodiment.

The dimension calculating unit 9 calculates dimensions based on the planes or the positions calculated as the start points of dimension calculation.

For example, as shown in FIG. 26, the dimension calculating unit 9 calculates depth PD of a pit by calculating a distance between an upper end plane of the landing sill and a point group belonging to a floor surface. For example, the dimension calculating unit 9 calculates height of the beam by calculating a distance between a lower end plane of the beam and the point group belonging to the floor surface. For example, the dimension calculating unit 9 calculates thickness of the beam from a difference between the heights of upper and lower end planes of the beam.

For example, the dimension calculating unit 9 calculates a distance between an inter-rail plane and a point group belonging to the rear wall surface. For example, the dimension calculating unit 9 calculates a distance between the inter-rail plane and a point group belonging to the landing sill. For example, the dimension calculating unit 9 calculates depth BH of the shaft by adding up the distance between the inter-rail plane and the point group belonging to the rear wall surface and the distance between the inter-rail plane and the point group belonging to the landing sill.

For example, the dimension calculating unit 9 calculates distances between the car rail distal end planes on the respective left and the right sides and point groups belonging the respective left and right wall surfaces. For example, the dimension calculating unit 9 calculates a distance between the left and right car rail distal end positions. For example, the dimension calculating unit 9 adds up the distances. For example, the dimension calculating unit 9 calculates lateral width AH of the shaft by adding left and right rail heights as standard information of the rails to the distances.

Note that, in the bottom floor, a wall surface below a floor level is sometimes waterproofed by mortar or the like. In this case, it is desirable to divide dimension calculation on upper and lower sides of the floor level. For example, 3D data of the shaft only has to be divided on the upper and lower sides across the upper end plane of the landing sill to separately perform measurement for the upper and lower sides.

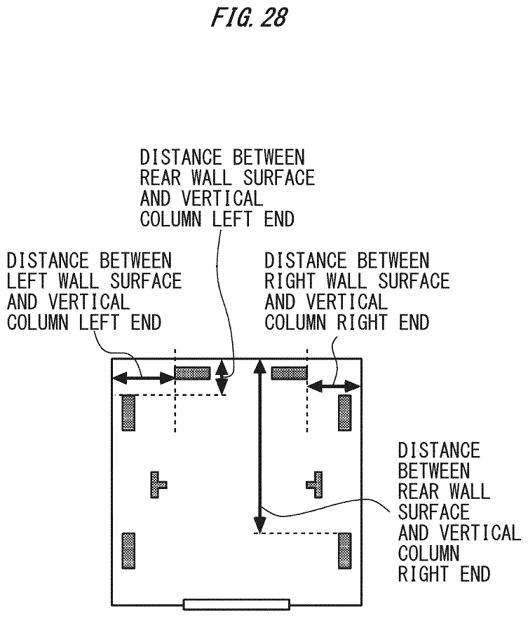

For example, as shown in FIG. 28, the dimension calculating unit 9 calculates distances between point groups belonging to the wall surfaces and the vertical column end planes.

According to the first embodiment explained above, the processing device 1 extracts a reference straight line and a reference plane of the shaft from 3D data of the shaft and aligns the 3D data of the shaft. Therefore, it is possible to align the 3D data of the shaft without requiring a special marker.

The processing device 1 extracts a reference straight line parallel to any one of the X axis, the Y axis, and the Z axis of the XYZ coordinate system. The processing device 1 extracts a reference plane having a normal line parallel to the extracted reference straight line. Therefore, it is possible to more accurately align the 3D data of the shaft.

The processing device 1 extracts, as the reference straight line, a straight line parallel to the boundary line between the landing sill and the hatch door. The processing device 1 extracts, as the reference plane, a plane parallel to the plane connecting the linear distal ends of the pair of car rails. Therefore, it is possible to more accurately align the 3D data of the shaft.

The processing device 1 generates a 2D projection image from the 3D data of the shaft. The processing device 1 extracts features from the 2D projection image. The processing device 1 specifies a reference position for processing of the 3D data of the shaft from the features of the 2D projection image. Therefore, it is possible to reduce a calculation load on the processing device 1. As a result, it is possible to reduce processing cost by the processing device 1.

The processing device 1 determines a pixel value of the projection image based on one of information concerning a color, information concerning reflection intensity, and information concerning a coordinate value of a projection point. Therefore, it is possible to more accurately extract the features of the 2D projection image.

The processing device 1 specifies a reference position in calculating dimensions of the shaft as the reference position for the processing of the 3D data. Therefore, it is possible to more accurately calculate dimensions of the structures in the shaft.

The processing device 1 generates a 2D projection image from the 3D data with the side surface or the floor surface of the shaft set as a projection direction. For example, the processing device 1 specifies the reference position based on a plane passing the upper end portion of the landing sill. For example, the processing device 1 specifies the reference position based on an inter-rail plane connecting the distal end portions of the pair of car rails. For example, the processing device 1 specifies the reference position based on a plane orthogonal to the inter-rail plane. For example, the processing device 1 specifies the reference position based on a plane passing the left and right end portions of the vertical column. For example, the processing device 1 specifies the reference position based on a plane passing the upper and lower end portions of the beam. Therefore, it is possible to more accurately calculate dimensions of various structures in the shaft.

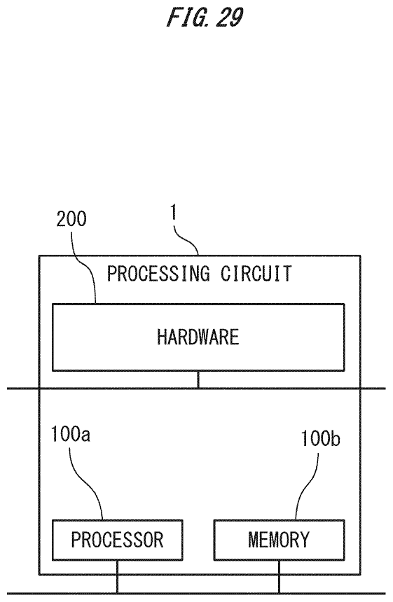

Subsequently, an example of the processing device 1 is explained with reference to FIG. 29.

FIG. 29 is a hardware block diagram of the elevator 3D data processing device in the first embodiment.

Functions of the processing device 1 can be realized by a processing circuit. For example, the processing circuit includes at least one processor 100a and at least one memory 100b. For example, the processing circuit includes at least one dedicated hardware 200.

When the processing circuit includes the at least one processor 100a and the at least one memory 100b, the functions of the processing device 1 are realized by software, firmware, or a combination of the software and the firmware. At least one of the software and the firmware is described as a program. At least one of the software and the firmware is stored in the at least one memory 100b. The at least one processor 100a reads out and executes the program stored in the at least one memory 100b to thereby realize the functions of the processing device 1. The at least one processor 100a is referred to as central processing unit, arithmetic processing device, microprocessor, microcomputer, or DSP as well. For example, the at least one memory 100b is a nonvolatile or volatile semiconductor memory such as a RAM, a ROM, a flash memory, an EPROM, or an EEPROM, a magnetic disk, a flexible disk, an optical disc, a compact disc, a minidisc, a DVD, or the like.

When the processing circuit includes the at least one dedicated hardware 200, the processing circuit is realized by, for example, a single circuit, a composite circuit, a programmed processor, a parallel-programmed processor, an ASIC, an FPGA, or a combination of the foregoing. For example, each of the functions of the processing device 1 is realized by the processing circuit. For example, the functions of the processing device 1 are collectively realized by the processing circuit.

A part of the functions of the processing device 1 may be realized by the dedicated hardware 200 and the other part may be realized by the software or the firmware. For example, the functions of the projection image feature extracting unit 7 may be realized by the processing circuit functioning as the dedicated hardware 200. The functions other than the functions of the projection image feature extracting unit 7 may be realized by the at least one processor 100a reading out and executing the program stored in the at least one memory 100b.

In this way, the processing circuit realizes the functions of the processing device 1 with the hardware 200, the software, the firmware, or a combination of the foregoing.

### Second Embodiment

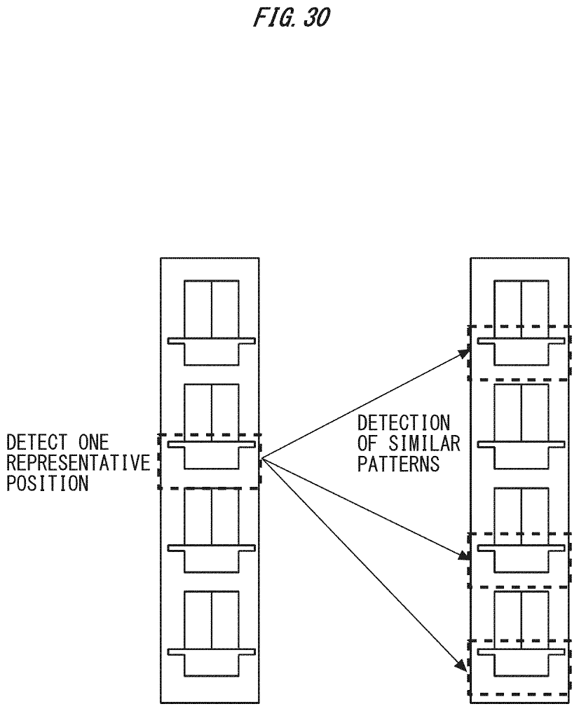

FIG. 30 to FIG. 34 are diagrams for explaining an elevator 3D data processing device in a second embodiment. Note that portions same as or equivalent to the portions in the first embodiment are denoted by the same reference numerals and signs. Explanation of the portions is omitted.

In the second embodiment, the processing device 1 extracts, from a generated projection image, features for dividing shaft data for each of floors. For example, the processing device 1 detects one representative position of a landing sill peripheral pattern and extracts similar patterns of a representative position to specify other hall positions.

Although not illustrated, the projection image feature extracting unit 7 uses an initial template modeled on a sill rail and an apron. Note that an initial template in a wider range including a door structure and the like may be used.

In template matching, a scanning range of a template may be an entire projection image or may be narrowed down.

For example, the projection image feature extracting unit 7 may, with an image center set as a center, convert a size [mm] of a maximum distance conceivable as an inter-floor distance of a shaft into a size [pix] on an image and perform the template matching using, as a search range, a rectangular area having the size as a size in the longitudinal direction. Alternatively, the projection image feature extracting unit 7 may cause a user to select a point around a landing sill through a point group data display device and may determine a search range centering on the selected point.

For example, when prior information such as an item table is absent, unevenness as a structure is present in a boundary between the landing sill and a hatch door or a boundary between the landing sill and an apron. Therefore, when a pixel value of a projection image is based on color information or a Z coordinate value of a point group, a clear lateral edge appears on the projection image.

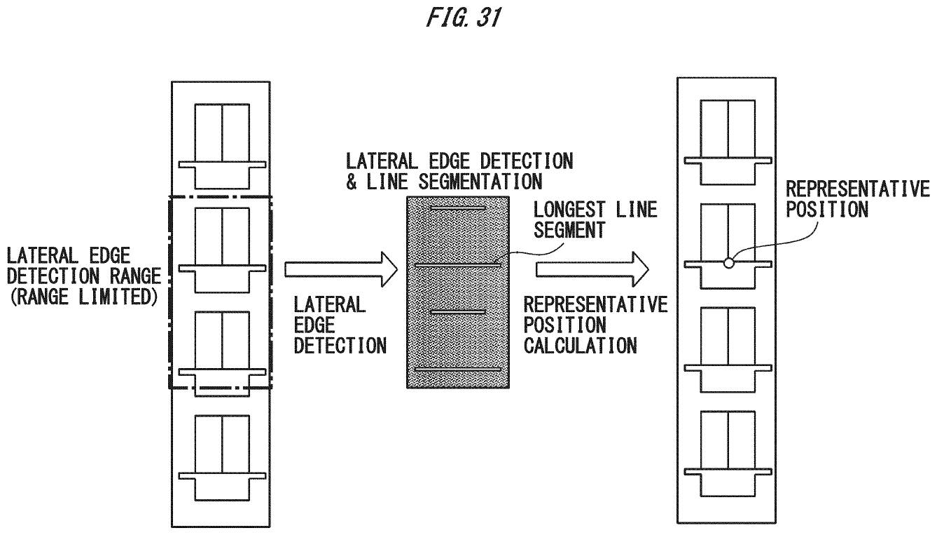

In this case, as shown in FIG. 31, the projection image feature extracting unit 7 applies an edge detector in the horizontal direction to the projection image to detect an edge in the lateral direction and converts the edge into line segments with edge coupling processing. The projection image feature extracting unit 7 determines, as a representative position, the longest line segment among these line segments. The line segment is sometimes extracted as a line segment having a gradient on an image with respect to the projection image. In this case, the projection image feature extracting unit 7 determines a center position of the line segment as the representative position.

The projection image feature extracting unit 7 sets the representative position as a reference and calculates image features of a peripheral area of the reference in the projection image. For example, the projection image feature extracting unit 7 extracts features in a rectangular area having a size set in advance centering on the representative position.

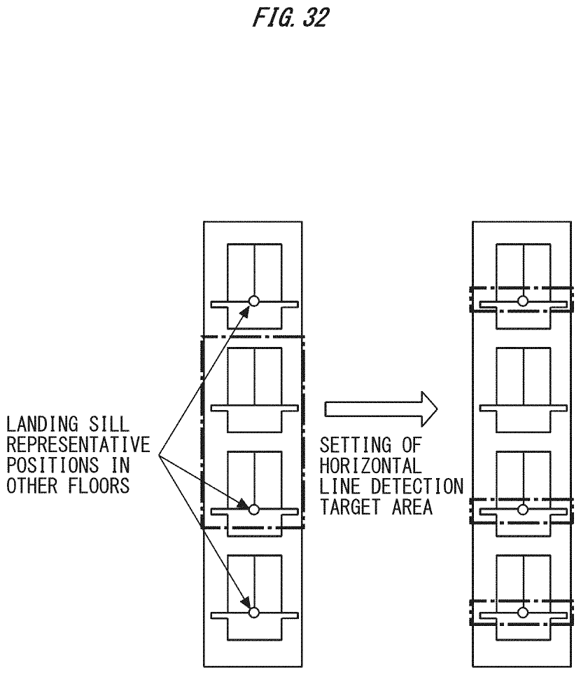

For example, as shown in FIG. 32, the reference position specifying unit 8 determines a position for dividing the shaft into data for each of floors. For example, the reference position specifying unit 8 sets the upper end line of the landing sill as a division reference boundary line.

At this time, the reference position specifying unit 8 applies an edge detector in the horizontal direction to a processing target image to detect an edge in the lateral direction and applies a horizontal line model using RANSAC or the like to an edge image to extract a horizontal line.

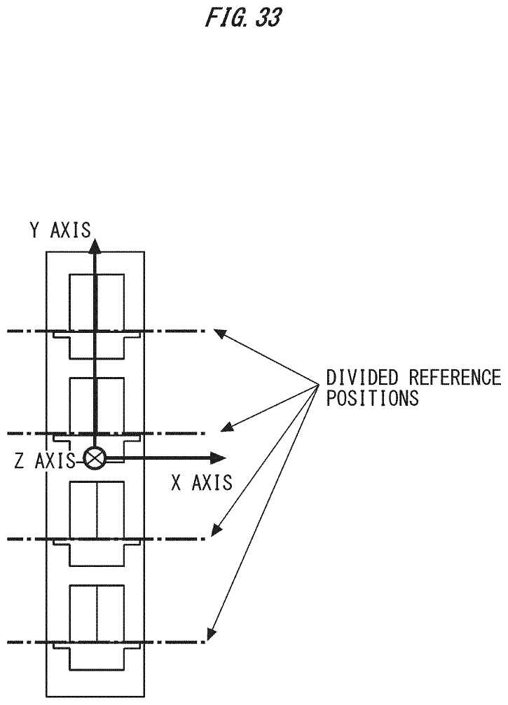

On the projection image, after determining a position of the upper end line of the landing sill concern each of the floors, the reference position specifying unit 8 converts the position into information concerning an XYZ coordinate system and determines a division reference position. For example, the upper end line of the landing sill is a line parallel to a ZX plane in the XYZ coordinate system. A Y coordinate value of the upper end line of the landing sill is fixed. At this time, as shown in FIG. 33, the reference position specifying unit 8 sets the Y coordinate value of the upper end line of the landing sill as a division reference coordinate.

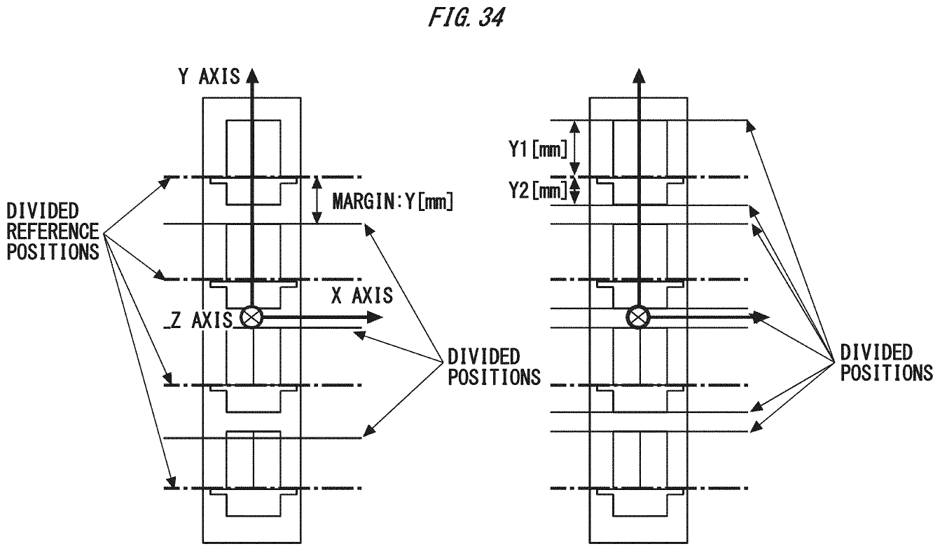

As shown in FIG. 34, the dimension calculating unit 9 divides point group data into data for each of the floors based on the division reference position determined by the reference position specifying unit 8.

For example, when a Y coordinate of a certain division reference position is Ys [mm] and a preset margin value is γ [mm], the dimension calculating unit 9 only has to divide the point group data by a Y coordinate value of Ys+γ.

When a processing target point group is narrowed down as much as possible, the dimension calculating unit 9 only has to segment and divide point group data, a certain division reference position Y coordinate value of which is present in a range of Ys+γ[mm] to Ys+γ2 [mm], as point group data of a relevant floor.

Note that, when a marker such as a monochrome checker pattern is arranged, a correlation value with the same template image may be set as a feature that should be calculated and a result position calculated by the template matching may be set as the division reference position.

According to the second embodiment explained above, the processing device 1 specifies a reference position in dividing the shaft as a reference position for 3D data processing. Therefore, it is possible to accurately divide the shaft.

The processing device 1 sets the side surface of the shaft as a projection direction and generates a 2D projection image from the 3D data. Therefore, it is possible to easily specify the reference position in dividing the shaft.

The processing device 1 extracts a texture pattern around the landing sill as a feature of the projection image. Therefore, it is possible to accurately divide the shaft.

### Third Embodiment

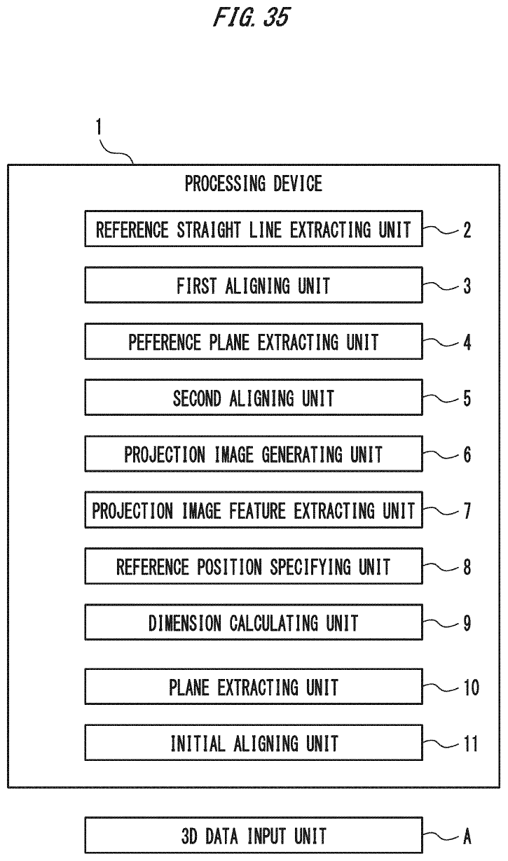

FIG. 35 is a block diagram of a processing system to which an elevator 3D data processing device in a third embodiment is applied. Note that portions same as or equivalent to the portions in the first embodiment are denoted by the same reference numerals and signs. Explanation of the portions is omitted.

As shown in FIG. 35, the processing device 1 in the third embodiment includes a plane extracting unit 10 and an initial aligning unit 11.

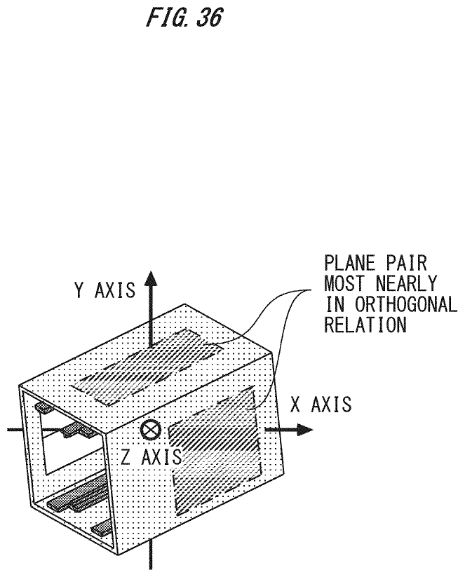

Subsequently, the plane extracting unit 10 is explained with reference to FIG. 36.

FIG. 36 is a diagram for explaining the plane extracting unit of the elevator 3D data processing device in the third embodiment.

As shown in FIG. 36, the plane extracting unit 10 extracts a pair of planes orthogonal to each other or most nearly orthogonal to each other from point group data. The extraction of the planes may be calculated by point group processing. For example, when planes are obtained in 3D measurement to which SLAM is applied, the planes may be used.

At this time, the plane extracting unit 10 does not always need to perform processing targeting all point groups. For example, the plane extracting unit 10 may extract planes targeting partial point groups. For example, the plane extracting unit 10 may set, as a processing target, a point group surrounded by a bounding box having a preset size from a point group center. For example, the plane extracting unit 10 may calculate a bounding box for a point group obtained by removing noise in a measurement point group and narrow down the processing target point group based on a size of the bounding box and a direction of a main axis. For example, the plane extracting unit 10 may perform sub-sampling at a preset interval and set a curtailed point group as a processing target.

The plane extracting unit 10 determines a pair of planes most nearly in an orthogonal relation out of an extracted plurality of planes.

At this time, the plane extracting unit 10 may try all pairs in a round robin manner and determine a pair of planes most nearly in an orthogonal relation. The plane extracting unit 10 may determine a pair of planes orthogonal to each other most in a combination of three planes, angles of which are in a fixed range from 90 degrees.

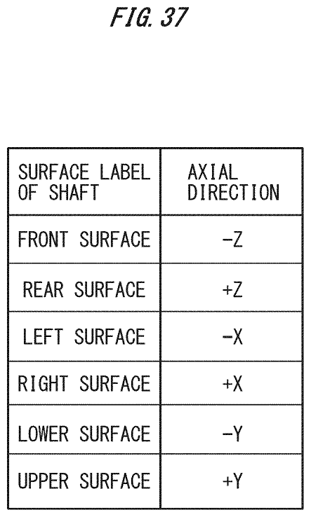

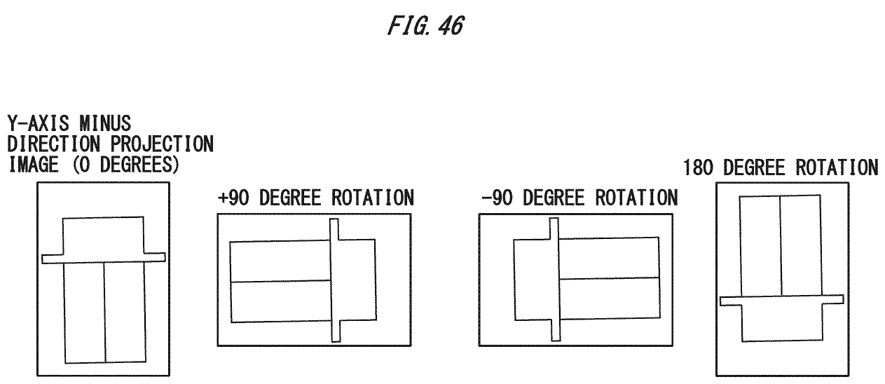

Subsequently, the initial aligning unit 11 is explained with reference to FIG. 37 to FIG. 48.

FIG. 37 to FIG. 48 are diagrams for explaining the initial aligning unit of the elevator 3D data processing device in the third embodiment.

The initial aligning unit 11 rotates, based on the pair of planes extracted by the plane extracting unit 10, the point group data to be substantially orthogonal to the surfaces of the shaft and the axial directions of the XYZ coordinate plane. For example, an aimed posture in the point group data is shown in FIG. 37.

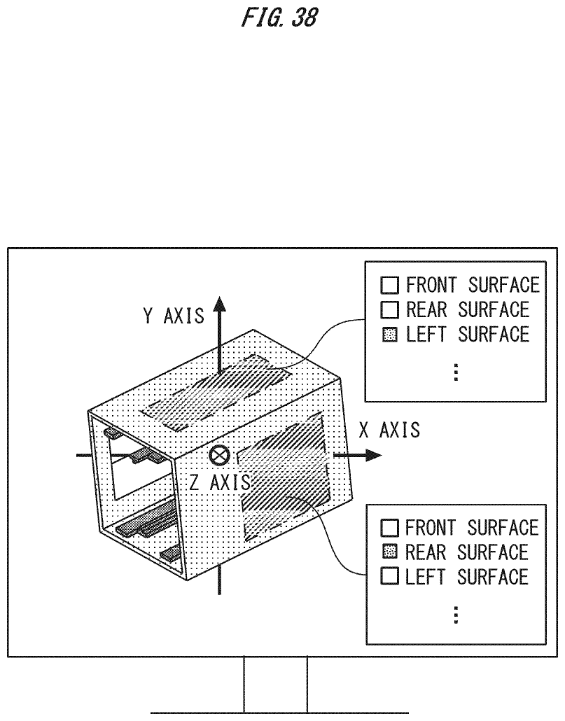

For example, as shown in FIG. 38, the initial aligning unit 11 displays the point group and the pair of planes through a point group data display device and urges a user to give any one of surface labels of the shaft to the pair of planes via the point group data display device. At this time, the initial aligning unit 11 aligns the point group data by performing posture conversion according to label information given to the respective planes such that normal lines of the planes coincide with a direction of a desired axis.

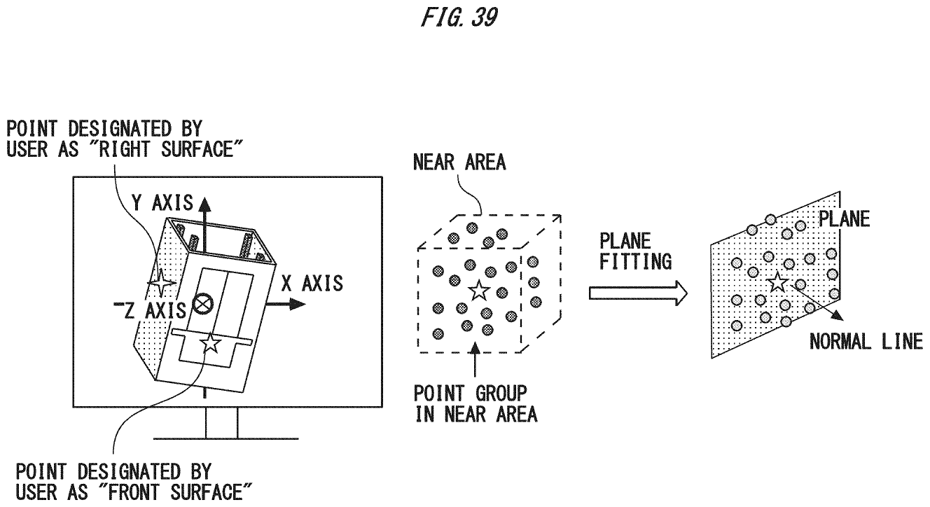

For example, as shown in FIG. 39, the initial aligning unit 11 displays the point group to the user through the point group data display device and urges the user to select points belonging to two surface adjacent to each other among the surfaces of the shaft. For example, the initial aligning unit 11 urges the user to select two points belonging to the “front surface” and the “right surface”. The initial aligning unit 11 extracts a point group in an area near the designated two points and performs plane fitting and then calculates, as Nf, a normal line around the point designated as the “front surface” and calculates, as Nr, a normal line around the point designated as the “right surface”. At this time, a size of the near area only has to be set in advance.

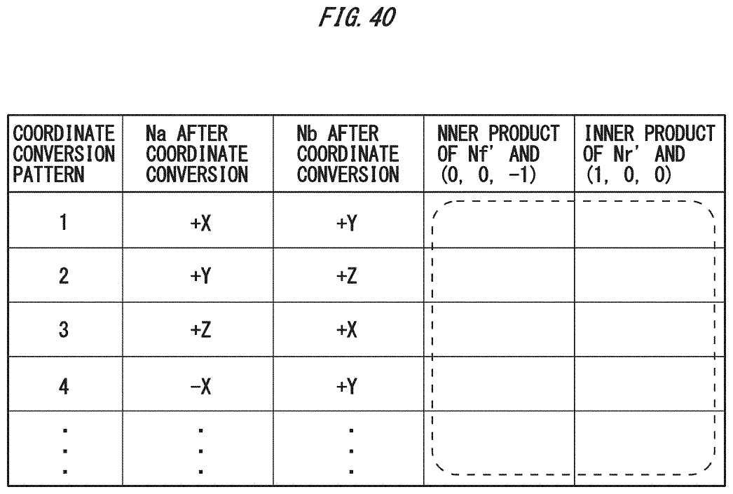

Thereafter, as shown in FIG. 40, the initial aligning unit 11 represents the pair of planes respectively as a plane “a” and a plane “b”. The initial aligning unit 11 represents a normal line of the plane “a” as Na. The initial aligning unit 11 represents a normal line of the plane “b” as Nb. The initial aligning unit 11 determines, among coordinate conversions for causing Na and Nb to substantially coincide with any direction of XY coordinate axes, coordinate conversion for bringing Nf′ and Nr′, which are normal lines after the coordinate conversion of Nf and N, closest to a Z-axis minus direction (0, 0, −1) and an X-axis plus direction (1, 0, 0). At this time, the initial aligning unit 11 only has to select coordinate conversion such that an inner product of the normal line Nf′ after the coordinate conversion and the Z-axis minus direction (0, 0, 1) and an inner product of the normal line Nr′ after the coordinate conversion and the X-axis plus direction (0, 0, 1) are the smallest. For example, the initial aligning unit 11 only has to determine coordinate conversion such that a sum of both the inner products is the smallest.

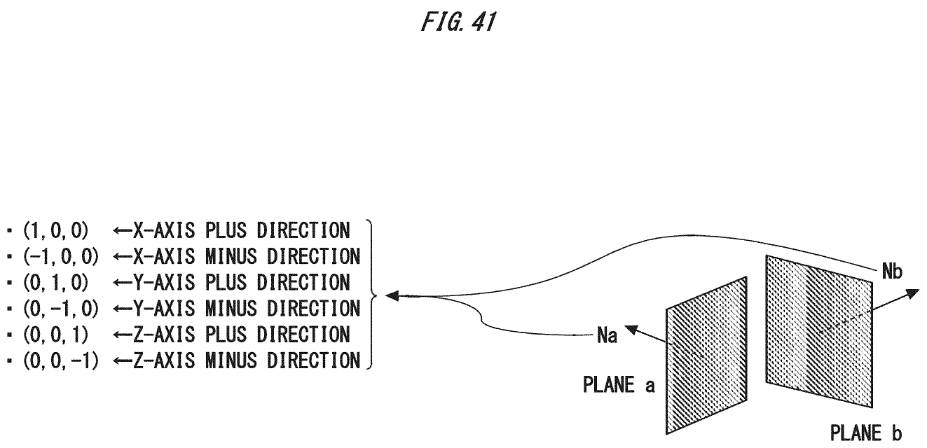

For example, as shown in FIG. 41, the initial aligning unit 11 searches for axial directions in which inner products with normal vectors representing directions of coordinate axes are the smallest. The initial aligning unit 11 performs coordinate conversion such that the normal lines coincide with the searched axial direction.

For example, the initial aligning unit 11 performs, concerning Na, conversion for causing Na to coincide with a matched axial direction and, thereafter, performs the conversion concerning Nb.

Note that axes to be caused to coincide may be uniform irrespective of a method of selecting a pair of planes.

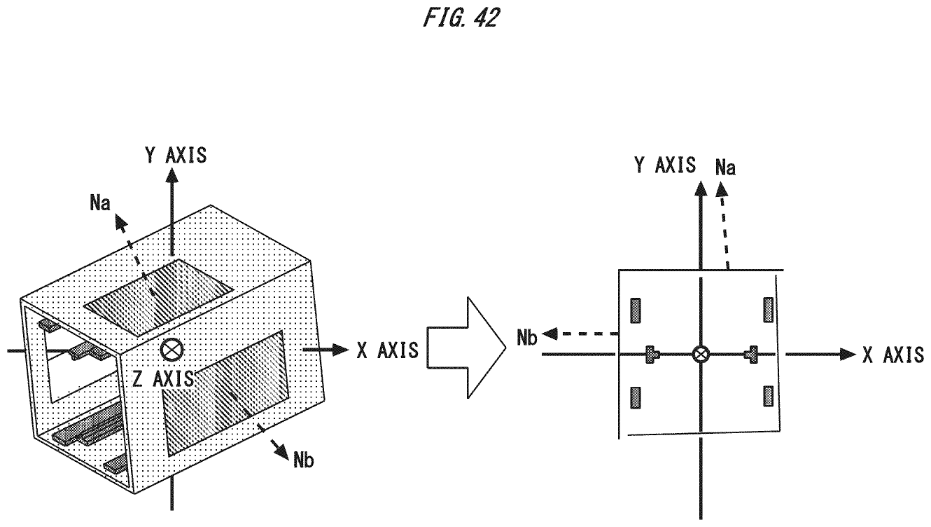

For example, when the pair of planes is equivalent to the wall surface or the bottom surface of the shaft or a structure equivalent to the wall surface or the bottom surface, as shown in FIG. 42, a relation between the point group data after alignment and the XYZ coordinate system is rotation transformed to a relation in which a relation between the surfaces of the shaft and the axes of the XYZ coordinate system is nearly orthogonal.

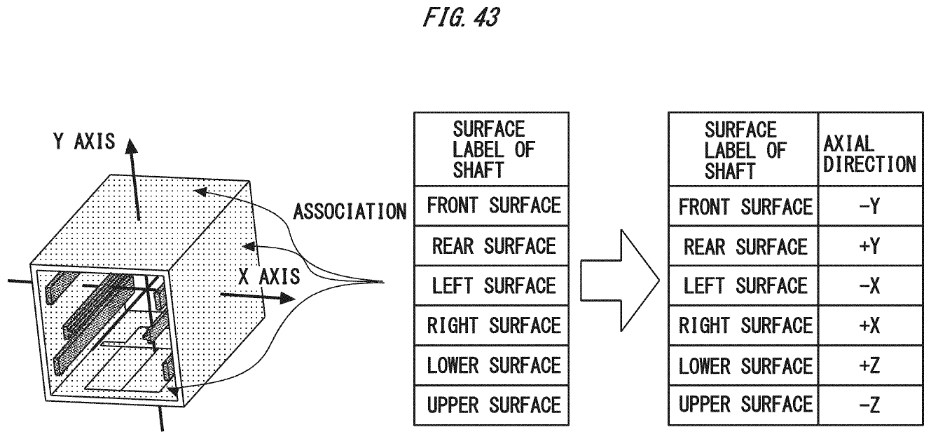

In this case, as shown in FIG. 43, concerning the point group data after the coordinate conversion, the initial aligning unit 11 performs labeling about to which direction of the wall surface, the bottom surface, and the ceiling of the shaft the directions of the axes in the XYZ coordinate system are equivalent. For example, the initial aligning unit 11 sets the surface labels of the shaft to “front surface”, “rear surface”, “left surface”, “right surface”, “bottom surface”, and “top surface”.

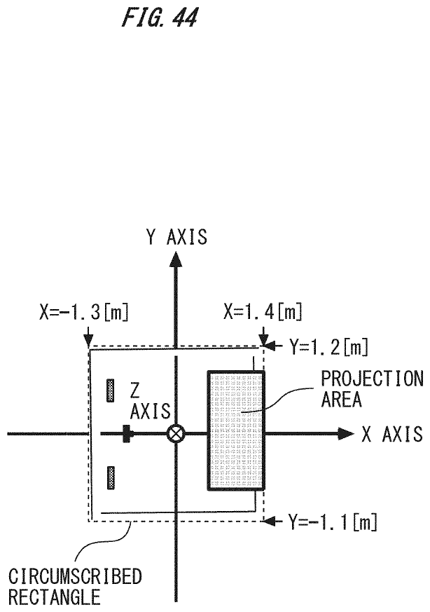

For example, as shown in FIG. 44, like the reference straight line extracting unit 2, the initial aligning unit 11 creates projection images in the plus direction and the minus direction of the XYZ axes. The initial aligning unit 11 only has to calculate a circumscribed rectangle of the point group data in a present stage and set maximum and minimum values indicated by the circumscribed rectangle as references of a projection range.

For example, a calculation result of the circumscribed rectangle is shown below.

X coordinate maximum value=1.4 [m]
X coordinate minimum value=−1.3 [m]
Y coordinate maximum value=1.2 [m]
Y coordinate minimum value=−1.1 [m]
Z coordinate maximum value=2.0 [m]
Z coordinate minimum value=−1.5 [m]

In this case, when a projection image in the X-axis plus direction is generated, in a projection area, α1, α2, and α3 are shown below as preset constant values.

Range of the X coordinate: 1.4−α1<x<1.4
Range of the Y coordinate: −1.0+α2<Y<1.2−α2
Range of the Z coordinate: −1.5+α3<z<2.0−α3

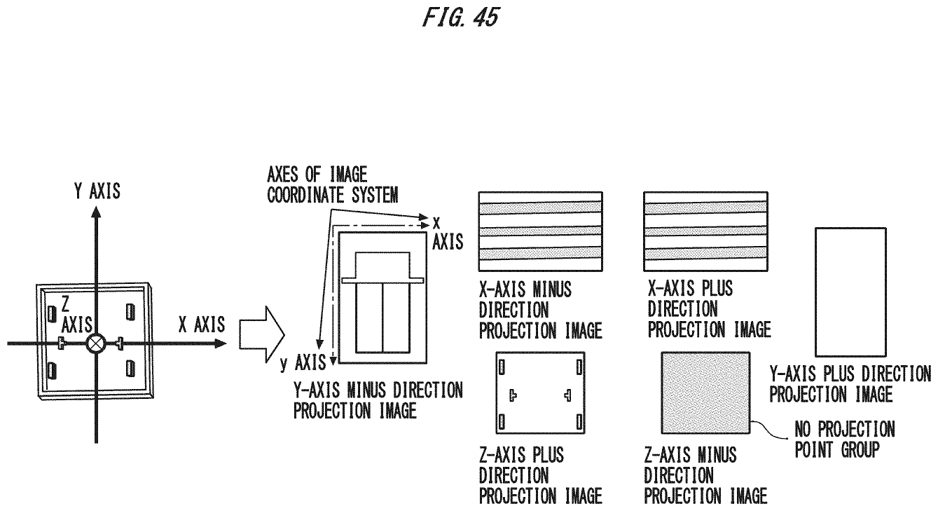

As a result, as shown in FIG. 45, six projection images are generated as a total in the axial directions. At this time, the projection images are texture patterns representing any ones of the surfaces of the shaft. Labeling of the surfaces of the shaft for the directions of the XYZ coordinate axes is performed for one of these projection images by estimating to which of the surfaces of the shaft the image is equivalent together with estimating a direction of the surface.

For example, the labeling may be performed in a framework of image recognition based on image features obtained from the projection images. In particular, in the projection image of the front surface, characteristic texture patterns such as the hatch door and the landing sill are present. Therefore, the projection image of the front surface is desirable as a target of the labeling. In this case, if edge features and position-invariable and scale-invariable local features are learned from several patterns as learning data of types, sizes, and layouts of the hatch door and the landing sill, recognition processing is easily performed.

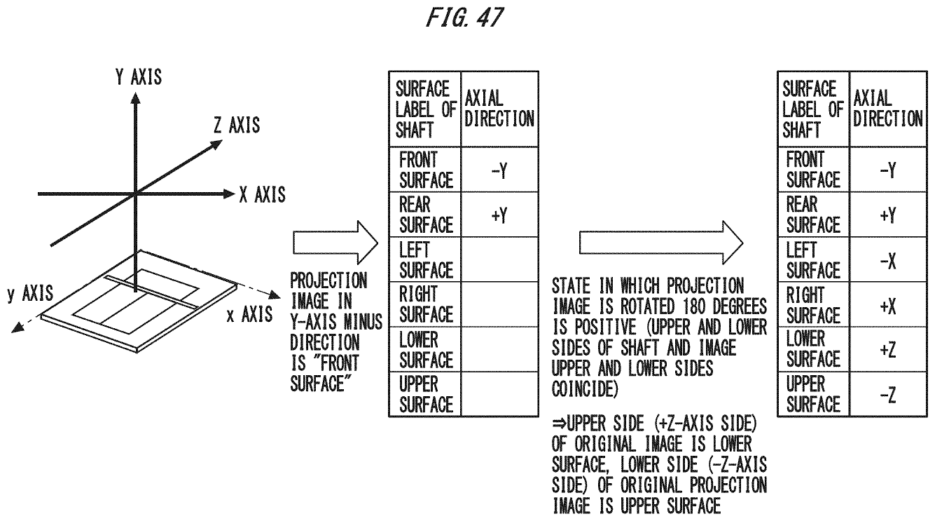

Actually, uncertainty of directions of the projection images needs to be considered. Therefore, as shown in FIG. 47, when the directions are also identified, for example, the initial aligning unit 11 only has to treat images obtained by rotating the projection images ±90 degrees and 180 degrees respectively as inputs as well, receive twenty-four types of projection images as inputs, and identify an image most likely to be the “front surface” out of the projection images.

The initial aligning unit 11 may exclude a projection image having an excessively small number of projection points among the projection images from processing targets.

In point group data in which the bottom surface and the ceiling surface of the shaft are originally hardly measured, the number of points projected onto a projection image is small. In this case, the initial aligning unit 11 may consider that the projection image is unlikely to be the “front surface” and exclude the projection surface from the processing targets in advance.

The initial aligning unit 11 may analytically perform the identification based on extraction of a rectangle like the hatch door, extraction of a horizontal line like the upper end of the landing sill, and the like.

Thereafter, as shown in FIG. 47 the initial aligning unit 11 recognizes which projection image is the “front surface” and at which degree the identified image is rotated with respect to the original projection image. The initial aligning unit 11 recognizes, from a correspondence relation with projection, in which axial direction the present front surface is located in the XYZ coordinate system. In this case, it is automatically determined in association to which axial directions the left and right surfaces, the bottom surface, and the top surface correspond.

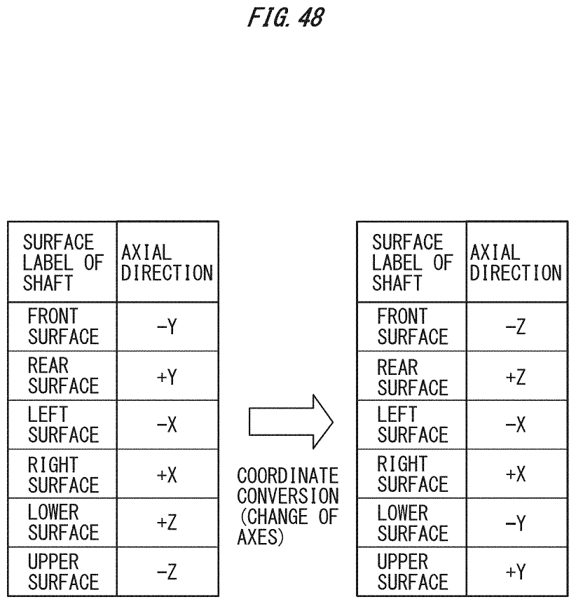

As a result, as shown in FIG. 48, the initial aligning unit 11 grasps a relation between labels of the surfaces of the shaft and the directions of the XYZ axes with respect to the present point group. The initial aligning unit 11 aligns the point group data by treating coordinate conversion from the correspondence relation into a desired correspondence relation as a change of the axes.

Note that, in the third embodiment, the reference straight line extracting unit 2 extracts a reference straight line from the point group data aligned by the initial aligning unit 11.

According to the third embodiment explained above, the processing device 1 extracts a pair of planes orthogonal to each other from the 3D data of the shaft. The processing device 1 aligns the 3D data of the shaft according to the pair of planes. Therefore, it is possible to align the 3D data of the shaft irrespective of a posture at a measurement time of a 3D input unit.

Note that, when the reference plane extracting unit 4 extracts a reference plane first, the reference plane extracting unit 4 only has to extract a reference plane of the shaft from the 3D data aligned by the initial aligning unit 11.

### INDUSTRIAL APPLICABILITY

As explained above, the elevator 3D data processing device of the present disclosure can be used in a system that processes data.

### REFERENCE SIGNS LIST

1 Processing device, 2 Reference straight line extracting unit, 3 First aligning unit, 4 Reference plane extracting unit, 5 Second aligning unit, 6 Projection image generating unit, 7 Projection image feature extracting unit, 8 Reference position specifying unit, 9 Dimension calculating unit, 10 Plane extracting unit, 11 Initial aligning unit, 100a Processor, 100b Memory, 200 Hardware

1.-5. (canceled)

6. An elevator 3D data processing device comprising:
a processor to execute a program, and
a memory to store the program which, when executed by the processor, performs process of,
when 3D data of a shaft of an elevator is aligned with a preset coordinate system, generating a 2D projection image from the 3D data,
extracting a feature of the projection image generated by the process of the generating, and
specifying a reference position for processing of the 3D data from the feature extracted by the process of the extracting,
wherein the process of the specifying is configured to specify a reference position in dividing the shaft as the reference position for the processing of the 3D data.

7. The elevator 3D data processing device according to claim 6, wherein the process of the generating is configured to generate a 2D projection image from the 3D data with a side surface of the shaft set as a projection direction.

8. The elevator 3D data processing device according to claim 7, wherein
the process of the generating is configured to generates generate the 2D projection image from the 3D data with a side surface on a hall side of the shaft set as the projection direction, and
the process of the extracting is configured to extract a texture pattern around a landing sill as the feature of the projection image.

9. An elevator 3D data processing device comprising:
a processor to execute a program, and
a memory to store the program which, when executed by the processor, performs process of,
when 3D data of a shaft of an elevator is aligned with a preset coordinate system, generating a 2D projection image from the 3D data,
extracting a feature of the projection image generated by the process of the generating, and
specifying a reference position for processing of the 3D data from the feature extracted by the process of the extracting,
wherein the process of the generating is configured to generate a 2D projection image from the 3D data with a side surface of the shaft set as a projection direction.

10. The elevator 3D data processing device according to claim 9, wherein the process of the specifying is configured to specify the reference position in calculating the dimension of the shaft based on any one plane among a plane that passes an upper end portion of a landing sill of the elevator, a plane that passes left and right end portions of a vertical column, and a plane that passes upper and lower end portions of a beam.

11. An elevator 3D data processing device comprising:
a processor to execute a program, and
a memory to store the program which, when executed by the processor, performs process of,
when 3D data of a shaft of an elevator is aligned with a preset coordinate system, generating a 2D projection image from the 3D data,
extracting a feature of the projection image generated by the process of the generating, and
specifying a reference position for processing of the 3D data from the feature extracted by the process of the extracting,
wherein the process of the specifying is configured to specify a reference position in calculating a dimension of the shaft as the reference position for the processing of the 3D data, and
wherein the process of the generating is configured to generate a 2D projection image from the 3D data with a side surface of the shaft set as a projection direction.

12. The elevator 3D data processing device according to claim 11, wherein the process of the specifying is configured to specify the reference position in calculating the dimension of the shaft based on any one plane among a plane that passes an upper end portion of a landing sill of the elevator, a plane that passes left and right end portions of a vertical column, and a plane that passes upper and lower end portions of a beam.
